(19) United States
(12) Patent Application Publication
(10) Pub. No.: US 2026/0019183 A1
(43) Pub. Date: Jan. 15, 2026

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Shengjiang CUI, Dongguan (CN); Weijie XU, Dongguan (CN)

(21) Appl. No.: 19/327,083

(22) Filed: Sep. 12, 2025

Related U.S. Application Data
(63) Continuation of application No. PCT/CN2023/092334, filed on May 5, 2023.

(51) Int. Cl. H04J 3/06; H04W 72/0453

(52) U.S. Cl. CPC H04J 3/0685; H04W 72/0453

(57) ABSTRACT

A wireless communication method includes: receiving, by an AMP device, a first signal and a second signal; performing, by the AMP device, processing of cross modulation or inter modulation on the first signal and the second signal to obtain a third signal; and determining, by the AMP device, a local clock based on the third signal.

### CROSS-REFERENCE TO RELATED APPLICATION

This application is a Continuation Application of International Application No. PCT/CN2023/092334 filed on May 5, 2023, which is incorporated herein by reference in its entirety.

### TECHNICAL FIELD

Embodiments of the present disclosure relate to the field of communication, and to a wireless communication method and a device.

### RELATED ART

Ambient power (AMP) devices have low complexity and low cost, enabling maintenance-free and battery-free, can support power harvesting and/or back scattering communication, and can implement high-density and large-scale deployment at a low cost. Considering the service characteristics of AMP devices, the limitations of AMP device capabilities, and the limitations of AMP device working power consumption, how the AMP device determines a local clock is a problem that needs to be solved.

### SUMMARY

The embodiments of the present disclosure provide a wireless communication method and a device.

In a first aspect, a wireless communication method is provided, and the method includes:
receiving, by an AMP device, a first signal and a second signal;
performing, by the AMP device, processing of cross modulation or inter modulation on the first signal and the second signal to obtain a third signal; and
determining, by the AMP device, a local clock based on the third signal.

In a second aspect, a wireless communication method is provided, and the method includes:
transmitting, by a first communication device, a first signal and/or a second signal to an AMP device;
where a third signal obtained through processing of cross modulation or inter modulation on the first signal and the second signal is used to determine a local clock of the AMP device; and
where in a case where the first communication device transmits only the first signal, the second signal is transmitted to the AMP device by a second communication device triggered by the first communication device; or in a case where the first communication device transmits only the second signal, the second signal is transmitted to the AMP device after being triggered by the second communication device.

In a third aspect, an AMP device is provided, and configured to perform the method in the first aspect.

Optionally, the AMP device includes a function module configured to perform the method in the first aspect.

In a fourth aspect, a communication device is provided. The communication device is a first communication device, and the communication device is configured to perform the method in the second aspect. Optionally, the communication device includes a function module configured to perform the method in the second aspect.

In a fifth aspect, an AMP device is provided, which includes a processor and a memory; the memory is configured to store a computer program, and the processor is configured to call the computer program stored in the memory and run the computer program to enable the AMP device to perform the method in the first aspect.

In a sixth aspect, a communication device is provided. The communication device is a first communication device, and the communication device includes a processor and a memory; the memory is configured to store a computer program, and the processor is configured to call the computer programs stored in the memory and run the computer programs to enable the communication device to perform the method in the second aspect.

In a seventh aspect, an apparatus is provided, which is configured to implement the method in any one of the first aspect and the second aspect.

Optionally, the apparatus includes: a processor, configured to call a computer program from a memory and run the computer program to enable a device equipped with the apparatus to perform the method in any one of the first aspect and the second aspect.

In an eighth aspect, a non-transitory computer-readable storage medium is provided, which is configured to store a computer program. The computer program enables a computer to execute the method in any one of the first aspect and the second aspect.

In a ninth aspect, a computer program product is provided, which includes computer program instructions. The computer program instructions enable a computer to perform the method in any one of the first aspect and the second aspect.

In a tenth aspect, a computer program is provided. The computer program, when executed on a computer, enables the computer to perform the method in any one of the first aspect and the second aspect.

### BRIEF DESCRIPTION OF THE DRAWINGS

FIG. 1 is a schematic diagram of a communication system architecture to which embodiments of the present disclosure are applied.

FIG. 2 is a schematic diagram of a zero-power communication provided in the present disclosure.

FIG. 3 is a schematic diagram of a back scattering communication provided in the present disclosure.

FIG. 4 is a schematic diagram of power harvesting provided in the present disclosure.

FIG. 5 is a circuit schematic diagram of a resistive load modulation provided in the present disclosure.

FIG. 6 is a schematic diagram of second-order cross modulation or inter modulation components provided in the present disclosure.

FIG. 7 is a schematic diagram of third-order cross modulation or inter modulation components provided in the present disclosure.

FIG. 8 is a schematic diagram of a channel bandwidth provided in the present disclosure.

FIG. 9 is a schematic diagram of an IF signal obtained by cross modulation or inter modulation of signals of two frequencies provided in the present disclosure.

FIG. 10 is a schematic flowchart of a wireless communication method provided in embodiments of the present disclosure.

FIGS. 11 to 13 are each a schematic diagram of transmitting a first signal and a second signal provided in embodiments of the present disclosure.

FIG. 14 is a schematic block diagram of an AMP device provided in embodiments of the present disclosure.

FIG. 15 is a schematic block diagram of a communication device provided in embodiments of the present disclosure.

FIG. 16 is a schematic block diagram of another communication device provided in embodiments of the present disclosure.

FIG. 17 is a schematic block diagram of an apparatus provided in embodiments of the present disclosure.

FIG. 18 is a schematic block diagram of a communication system provided in embodiments of the present disclosure.

### DETAILED DESCRIPTION

The technical solutions in the embodiments of the present disclosure will be described below in conjunction with the accompanying drawings in the embodiments of the present disclosure. Obviously, the described embodiments are merely some but not all embodiments of the present disclosure. With respect to the embodiments of the present disclosure, all other embodiments obtained by a person of ordinary skill in the art belong to the protection scope of the present disclosure.

The technical solutions of the embodiments of the present disclosure may be applied to various communication systems, such as a global system of mobile communication (GSM) system, code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of an NR system, an LTE-based access to unlicensed spectrum (LTE-U) system, an NR-based access to unlicensed spectrum (NR-U) system, a non-terrestrial networks (NTN) system, a universal mobile telecommunication system (UMTS), a wireless local area networks (WLAN), Internet of Things (IoT), wireless fidelity (WiFi), a 5th-generation (5G) system, a 6th-generation (6G) system, or other communication systems.

Generally speaking, traditional communication systems support a limited number of connections, which are easy to be implemented. However, with the development of the communication technology, the mobile communication system will not only support the traditional communication, but also support, for example, device to device (D2D) communication, machine to machine (M2M) communication, machine type communication (MTC), vehicle to vehicle (V2V) communication, sidelink (SL) communication, vehicle to everything (V2X) communication, and the like. The embodiments of the present disclosure may also be applied to these communication systems.

In some embodiments, the communication system in the embodiments of the present disclosure may be applied to a carrier aggregation (CA) scenario, may also be applied to a dual connectivity (DC) scenario, and may also be applied to a standalone (SA) network deployment scenario or a non-standalone (NSA) network deployment scenario.

In some embodiments, the communication system in the embodiments of the present disclosure may be applied to an unlicensed spectrum. The unlicensed spectrum may also be considered as a shared spectrum. Alternatively, the communication system in the embodiments of the present disclosure may also be applied to a licensed spectrum. The licensed spectrum may also be considered as an unshared spectrum.

In some embodiments, the communication system in the embodiments of the present disclosure may be applied to an FR1 frequency band (corresponding to a frequency band range of 410 MHz to 7.125 GHz), or may also be applied to an FR2 frequency band (corresponding to a frequency band range of 24.25 GHz to 52.6 GHz), or may also be applied to a new frequency band, such as a high-frequency frequency band corresponding to a frequency band range of 52.6 GHz to 71 GHz or corresponding to a frequency band range of 71 GHz to 114.25 GHz.

The embodiments of the present disclosure describe various embodiments in conjunction with an AMP device and a communication device. The AMP device may also be referred to as a zero-power device or an ambient power Internet of Things device. The communication device may be a network device (e.g., a base stations), or an access point (AP), or a terminal device, or a station (STA), or a transmission reception point (TRP), or a relay device. Of course, the communication device may also be any of other devices, which is not limited in the embodiments of the present disclosure.

The terminal device may be a cellular phone, a cordless phone, a session initiation protocol (SIP) phone, a wireless local loop (WLL) station, a personal digital assistant (PDA) device, a handheld device with a wireless communication function, a computing device or any of other processing devices connected to a wireless modem, a vehicle-mounted device, a wearable device, a terminal device in a next generation communication system such as an NR network, a terminal device in a public land mobile network (PLMN) network evolved in the future, or the like.

In the embodiments of the present disclosure, the terminal device may be deployed on land, which includes indoor or outdoor, in handheld, wearable or vehicle-mounted; may also be deployed on water surface (e.g., on a ship); and may also be deployed in the air (e.g., on an airplane, a balloon, a satellite, or the like).

In the embodiments of the present disclosure, the terminal device may be a mobile phone, a tablet computer (Pad), a computer with a wireless transceiving function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city or smart home, a vehicle-mounted communication device, a wireless communication chip/application specific integrated circuit (ASIC)/system on chip (SoC), or the like.

As an example but not a limitation, in the embodiments of the present disclosure, the terminal device may also be a wearable device. The wearable device may also be referred to as a wearable smart device, which is a generic term for wearable devices, into which the daily wear is intelligently designed and developed by applying wearable technologies, such as glasses, gloves, watches, clothing and shoes. The wearable device is a portable device that is worn directly on the body, or integrated into the user's clothing or accessories. The wearable device is not just a hardware device, but also accomplishes powerful functions through software supporting, data interaction, and cloud interaction. Generalized wearable smart devices include those are fully functional, large in size, and can accomplish all or part of functions without relying on a smartphone, such as smart watches or smart glasses, as well as those that, only focus on a certain type of application function and need to be used in conjunction with other devices (such as a smartphone), such as various types of smart bracelets or smart jewelry for monitoring physical sign.

In the embodiments of the present disclosure, the network device may be a device for communicating with a mobile device. The network device may be an access point (AP) in the WLAN, a base station (Base Transceiver Station) in GSM or CDMA, may also be a base station (NodeB) in the WCDMA, or may also be an evolutional base station (Evolutional Node B) in the LTE, a relay station or an access point, a vehicle-mounted device, a wearable device, a network device or base station (gNB) or transmission reception point (TRP) in an NR network, a network device in the PLMN network evolved in the future or the NTN network, or the like.

As an example but not a limitation, in the embodiments of the present disclosure, the network device may have a mobile characteristic. For example, the network device may be a moving device. In some embodiments, the network device may be a satellite or a balloon station. For example, the satellite may be a low earth orbit (LEO) satellite, a medium earth orbit (MEO) satellite, a geostationary earth orbit (GEO) satellite, a high elliptical orbit (HEO) satellite, or the like. In some embodiments, the network device may also be a base station provided on land, water, and other places.

In the embodiments of the present disclosure, the network device may provide a service for a cell, and the terminal device may communicate with the network device through a transmission resource (e.g., a frequency domain resource, or a spectrum resource) used by the cell. The cell may be a cell corresponding to the network device (e.g., a base station), and the cell may belong to a macro base station or may also belong to a base station corresponding to a small cell. The small cells here may include a metro cell, a micro cell, a pico cell, a femto cell, etc. These small cells have characteristics of small coverage range and low transmission power, which are applicable for providing a data transmission service with high speed.

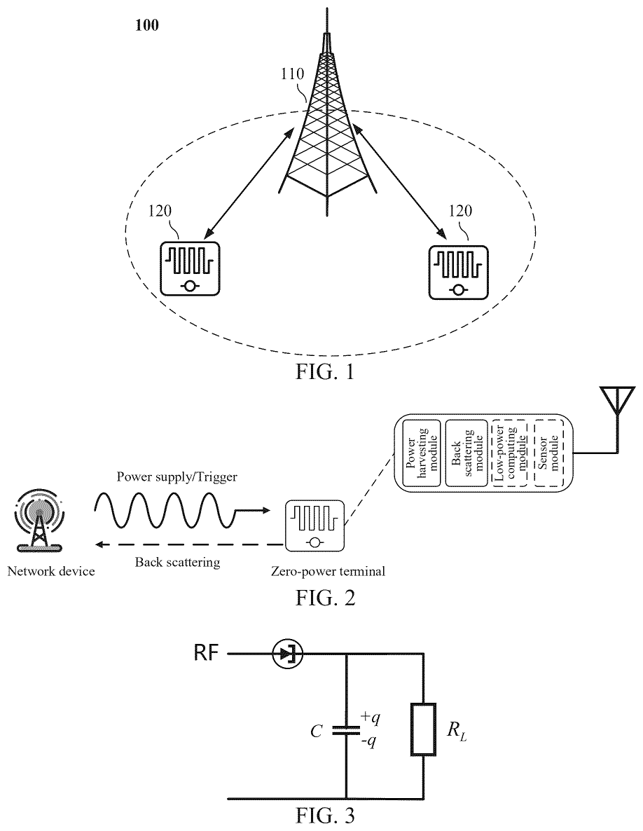

For example, a communication system 100 applied by the embodiments of the present disclosure is shown in FIG. 1. The communication system 100 may include a communication device 110, and the communication device 110 may be a device that communicates with an AMP device 120 (or referred to as a zero-power device). The communication device 110 may provide communication coverage for a specific geographical area and may communicate with AMP devices located within the coverage area.

FIG. 1 exemplarily shows one communication device and two AMP devices. Optionally, the communication system 100 may include a plurality of communication devices, and may include another number of AMP devices within a coverage area of each communication device, which is not limited in the embodiments of the present disclosure.

In some embodiments, the communication system 100 may further include other network entities such as a network controller and a mobility management entity, which is not limited in the embodiments of the present disclosure.

It should be understood that in the embodiments of the present disclosure, a device with a communication function in the network/system may be referred to as a communication device. Taking the communication system 100 shown in FIG. 1 as an example, communication devices may include the communication device 110 and the AMP device 120 that have the communication function. The communication device 110 and the AMP device 120 may be the devices described above, which will not be repeated here. The communication devices may further include other devices in the communication system 100, e.g., other network entities such as a network controller and a mobile management entity, which are not limited in the embodiments of the present disclosure.

It should be understood that the terms “system” and “network” are often used interchangeably herein. The term “and/or” used herein is only an association relationship for describing associated objects, which indicates that there may be three kinds of relationships. For example, A and/or B may represent three situations that: A exists alone, both A and B exist, and B exists alone. In addition, the character “/” used herein generally indicates that associated objects before and after the character “/” are in an “or” relationship.

The terms used in the implementations of the present disclosure are only used to explain embodiments of the present disclosure, and are not intended to limit the present disclosure. The terms such as “first,” “second,” “third,” and “fourth” in the specification, claims and drawings of the present disclosure are used to distinguish different objects, rather than to describe a specific order. In addition, the terms “includes,” “comprises,” “has,” and any variations thereof, are intended to cover a non-exclusive inclusion.

It should be understood that the “indicate” mentioned in the embodiments of the present disclosure may mean a direct indication or an indirect indication, or may represent that there is an association relationship. For example, A indicates B, which may mean that A directly indicates B, such as B may be obtained by A; A indicates B, which may also mean that A indirectly indicates B, such as A indicates C, and B may be obtained by C; and A indicates B, which may also mean that there is an association relationship between A and B.

It should be understood that the “at least one or at least one of” mentioned in the embodiments of the present disclosure may mean “one or more”, and the “positive integer” mentioned in the embodiments of the present disclosure may mean “1, 2, 3, . . . and other values,” and the “non-negative integer” mentioned in the embodiments of the present disclosure may mean “0, 1, 2, 3, . . . and other values,” and the “integer” mentioned in the embodiments of the present disclosure may mean “ . . . , −3, −2, −1, 0, 1, 2, 3, . . . and other values,” which may be replaced with any possible value based on the requirements of the embodiments.

It should be understood that the figures and/or tables shown in the embodiments of the present disclosure are only examples. Optionally, in some cases, some of the information contained in the figures and/or tables shown in the embodiments of the present disclosure may independently constitute an optional embodiment. For example, each row or each column in a table may independently constitute an optional embodiment, which is not limited in the present disclosure.

In the description of the embodiments of the present disclosure, the term “correspond” may mean that there is a direct correspondence or an indirect correspondence between the two, or may mean that there is an associated relationship between the two, or may mean a relationship of indicating and being indicated or a relationship of configuring and being configured.

In the embodiments of the present disclosure, “pre-defined” or “pre-configured” may be implemented by pre-storing corresponding codes, tables or other methods that can be used to indicate related information in devices (e.g., including a terminal device and a network device), and its implementation is not limited in the present disclosure. For example, the “pre-defined” may refer to what is defined in the protocol.

In the embodiments of the present disclosure, the “protocol” may refer to a standard protocol in the field of communications, which may be, for example, an evolution of an existing LTE protocol, NR protocol, or Wi-Fi protocol, or an evolution of a related protocol of other communication systems related thereto, which is not limited in the present disclosure.

In order to facilitate better understanding of the embodiments of the present disclosure, the zero-power communication technology related to the present disclosure is described.

Zero-power communication uses power harvesting and/or back scattering communication technology. A zero-power communication network consists of a network device and a zero-power device, as shown in FIG. 2. The network device is used to transmit wireless power supply signals, downlink communication signals to the zero-power device and receive back scattering signals from the zero-power device. A basic zero-power device consists of a power harvesting module, a back scattering communication module, and a low-power computing module. In addition, the zero-power device may further have a memory or a sensor for storing some basic information (e.g., object identification) or obtaining sensor data such as ambient temperature and ambient humidity.

The key technologies of zero-power communication mainly include radio frequency (RF) power harvesting and back scattering communication.

Optionally, RF power harvesting may be shown in FIG. 3. The RF power harvesting module collects electromagnetic wave power in space based on the principle of electromagnetic induction, and then obtains power required to drive the zero-power device to work, e.g., driving a low-power demodulation and modulation module, and a sensor, memory reading, etc. Therefore, the zero-power device does not require traditional batteries.

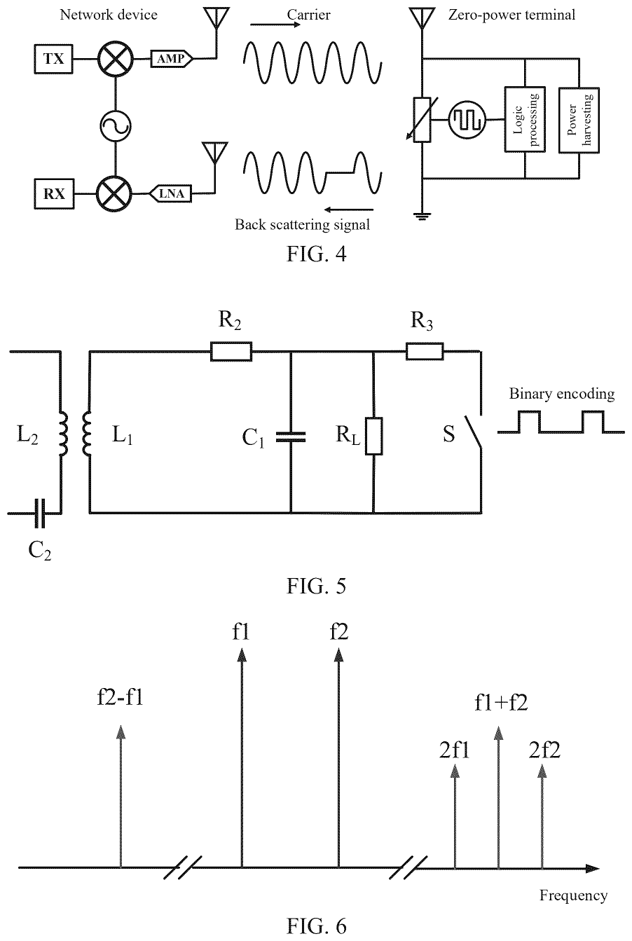

Optionally, the back scattering communication may be shown in FIG. 4. A zero-power communication terminal receives a wireless signal transmitted by the network, modulates the wireless signal, loads information to be transmitted, and radiates the modulated signal from an antenna. This information transmission process is referred to as the back scattering communication. Back scattering and load modulation function are inseparable. The load modulation completes the modulation process by adjusting and controlling circuit parameters of an oscillation loop of the zero-power device according to rhythm of a data stream, to enable parameters such as a magnitude of the impedance of an electronic tag to change accordingly. Load modulation technology mainly includes two manners: resistive load modulation and capacitive load modulation. In the resistive load modulation, a resistor is connected in parallel to a load, the resistor is switched on or off based on the control of a binary data stream, as shown in FIG. 5. The on or off of the resistor will cause a change in circuit voltage, thereby accomplishing amplitude shift keying (ASK) modulation, that is, by adjusting an amplitude of a back scattering signal of the zero-power device, the modulation and transmission of the signal are accomplished. Similarly, in the capacitive load modulation, resonant frequency of a circuit may be changed by the on or off of a capacitor, thereby accomplishing frequency shift keying (FSK) modulation, that is, by adjusting an operating frequency of a back scattering signal of the zero-power device, the modulation and transmission of the signal are accomplished.

It can be seen that the zero-power device uses the load modulation to modulate information on an incoming wave signal, thereby accomplishing a back scattering communication process. Therefore, the zero-power device has significant advantages that:
(1) the zero-power device does not actively transmit signals, and thus the zero-power device does not require a complex radio frequency link, such as a power amplifier (PA), a radio frequency filter, or the like;
(2) the zero-power device does not need to actively generate high-frequency signals, and thus the zero-power device does not require a high-frequency crystal oscillator; and
(3) with the help of back scattering communication, signal transmission of the zero-power device does not need to consume power of the zero-power device itself.

The zero-power communication, owing to significant advantages such as ultra-low cost, zero power consumption and small size, may be widely used in various industries such as logistics, smart warehousing, smart agriculture, power and electricity, industrial Internet for vertical industries; and it may also be applied to personal applications such as smart wearables and smart homes.

In order to facilitate better understanding of the embodiments of the present disclosure, power supply signals and trigger signals in the zero-power communication system related to the present disclosure are described.

Power supply signal: from the perspective of power supply signal carrier, the power supply signal carrier may be a base station, a smart phone, a smart gateway, a charging station, a micro base station, or the like; from the perspective of frequency band, radio waves used for power supply may be low frequency, medium frequency, high frequency, or the like; and from the perspective of waveform, radio waves used for power supply may be sine waves, square waves, triangle waves, pulses, rectangular waves, or the like; in addition, the radio waves used for power supply may be continuous waves or discontinuous waves (i.e., a certain period of interruption is allowed). The power supply signal may be a signal specified in the 3GPP standard, such as a sounding reference signal (SRS), a physical uplink shared channel (PUSCH), a physical random access channel (PRACH), a physical uplink control channel (PUCCH), a physical downlink control channel (PDCCH), a physical downlink shared channel (PDSCH), a physical broadcast channel (PBCH), or the like.

Trigger signal/control information: from the perspective of trigger signal carrier, the trigger signal carrier may be a base station, a smart phone, a smart gateway, or the like; from the perspective of frequency band, radio waves used for power supply may be low frequency, medium frequency, high frequency, or the like; and from the perspective of waveform, radio waves used for power supply may be sine waves, square waves, triangle waves, pulses, rectangular waves, or the like; in addition, the radio waves used for power supply may be continuous waves or discontinuous waves (i.e., a certain period of interruption is allowed). The trigger signal may be a signal specified in the 3GPP standard, such as an SRS, a PUSCH, a PRACH, a PUCCH, a PDCCH, a PDSCH, a PBCH, or the like; or the trigger signal may be a new signal.

In order to facilitate better understanding of the embodiments of the present disclosure, the classification of zero-power devices related to the present disclosure is described below.

Optionally, based on power sources and usage manners of the zero-power devices, the zero-power devices may be divided into passive zero-power devices, semi-passive zero-power devices, and active zero-power devices.

### 1) Passive Zero-Power Device

The zero-power device does not need a built-in battery. When the zero-power device approaches a network device (e.g., a reader/writer of a radio frequency identification (RFID) system), the zero-power device is located within a near-field range formed by radiation of an antenna of the network device. Therefore, an antenna of the zero-power device generates an induced current through electromagnetic induction, and the induced current drives a low-power chip circuit of the zero-power device. Thus, the signal demodulation of a forward link (a downlink, which is a link from the network device to the zero-power device) and the signal modulation of a backward link (an uplink, which is a link from the zero-power device to the network device) are implemented. For a back scattering link, the zero-power device transmits signals in a back scattering manner.

It can be seen that the passive zero-power device does not need the built-in battery to drive either the forward link or the reverse link, and is a truly zero-power device.

The passive zero-power device does not need the battery, and a radio frequency circuit and a baseband circuit are both very simple. For example, the passive zero-power device does not need components, such as a low-noise amplifier (LNA), a power amplifier (PA), a crystal oscillator, and an analog-to-digital conversion (ADC). Therefore, the passive zero-power device has many advantages, such as small size, light weight, very low price, and long service life.

The passive zero-power terminal may also support other power collection manners. By collecting power from the environment (e.g., light power, thermal power, kinetic power, mechanical power, and the like), the passive zero-power terminal may obtain power for driving circuits and support terminal devices to communicate.

### 2) Semi-Passive Zero-Power Device

The semi-passive zero-power device itself is not installed with a conventional battery, but may use a radio frequency (RF) power harvesting module to harvest radio wave power, or use a power harvesting module to harvest power from the environment (e.g., solar power, thermal power, mechanical vibration energy, and the like); and simultaneously, the semi-passive zero-power device stores the harvested power in a power storage unit (e.g., a capacitor). After obtaining power, the power storage unit may drive a low-power chip circuit of the zero-power device. Thus, the signal demodulation of a forward link and the signal modulation of a backward link are implemented. For a back scattering link, the zero-power devices transmits signals in a back scattering manner.

It can be seen that the semi-passive zero-power device does not need the built-in battery to drive either the forward link or the backward link. Although the power stored in the capacitor is used during work, the power comes from the radio power harvested by the power harvesting module. Therefore, the semi-passive zero-power device is also a truly zero-power device.

The semi-passive zero-power device inherits many advantages of the passive zero-power device, and thus the semi-passive zero-power device has many advantages, such as small size, light weight, very low price, and long service life.

### 3) Active Zero-Power Device

Some zero-power devices used in some scenarios may also be active zero-power devices. Such terminals have a built-in battery (a conventional battery, such as a dry battery, or a rechargeable lithium battery). The battery is used to drive a low-power chip circuit of the zero-power device. Thus, the signal demodulation of a forward link and the signal modulation of a backward link are implemented. However, for a back scattering link, the zero-power device transmits signals in a back scattering manner. Therefore, the zero power consumption of such terminals is mainly reflected in the fact that the signal transmission of the backward link does not need the power of the terminal itself, but uses the back scattering manner. Although the active zero-power device uses the battery, the power consumption is very low due to the use of ultra-low power communication technology. Therefore, compared with the related art, the working life of the battery may be significantly extended.

For the active zero-power device, the built-in battery supplies power to the RFID chip, thereby increasing a reading and write distance of a tag, to improve communication reliability. Therefore, the active zero-power device may be applied in some scenarios with relatively high requirements on a communication distance, a reading latency, etc.

Some zero-power terminals, such as semi-passive zero-power terminals or active zero-power terminals, may have the capability of active transmission, that is, in addition to communicating by the back scattering manner, the backward link may also communicate by active transmission.

As we all know, the business types of zero-power Internet of Things and other business types of Internet of Things will also be dominated by uplink business. Therefore, based on transmitter types, the zero-power devices may be divided into a zero-power device based on back scattering, a zero-power device based on an active transmitter, and a zero-power device with both back scattering and an active transmitter.

### 1) Zero-Power Device Based on Back Scattering

The back scattering manner as described above is used by this type of zero-power device to transmit uplink data. Such device does not have an active transmitter for active transmission, but only a transmitter for back scattering. Therefore, when such terminal transmits data, a network device is required to provide a carrier, and such terminal device performs back scattering based on the carrier to implement data transmission.

### 2) Zero-Power Device Based on Active Transmitter

An active transmitter with active transmission capability is used by this type of zero-power device to transmit uplink data. Therefore, when transmitting data, this type of zero-power device may use its own active transmitter to transmit data without the need for a network device to provide a carrier. An active transmitter suitable for the zero-power device may be, for example, an ultra-low-power ASK transmitter, an ultra-low-power FSK transmitter, or the like. Based on current implementations, when transmitting a 100 μW signal, the overall power consumption of such transmitter may be reduced to 400 to 600 μW.

3) Zero-Power Device with Both Back Scattering and Active Transmitter

This type of terminal may support both the back scattering and the active transmitter. The terminal may determine which uplink signal transmission manner to be used based on different situations (e.g., power conditions, and available ambient power) or based on scheduling of the network device: whether the active transmission is used by the back scattering or the active transmitter.

In order to facilitate better understanding of the embodiments of the present disclosure, a cellular passive Internet of Things related to the present disclosure is described below.

The cellular Internet of Things is booming. For example, 3GPP has standardized Internet of Things technologies such as narrow band Internet of Things (NB-IoT), machine type communication (MTC), and reduced capability (RedCap). However, there are still Internet of Things communication needs in many scenarios that cannot be met using existing technologies.

An example is a harsh communication environment. Some Internet of Things scenarios may face extreme environments such as high temperature, extremely low temperature, high humidity, high pressure, high radiation or high-speed movement, for example, ultra-high voltage substations, high-speed train track monitoring, environmental monitoring in high-cold areas, industrial production lines, and the like. In these scenarios, existing Internet of Things terminals will not be able to work due to limitations of working environment of conventional power supplies. In addition, extreme working environments are not conducive to Internet of Things maintenance, such as battery replacement.

Another example is the demand for extremely small terminal sizes. Some Internet of Things communication scenarios, such as food traceability, commodity circulation, and smart wearables, require terminals to be extremely small in size to facilitate use in these scenarios. For example, Internet of Things terminals used for commodity management in the circulation process usually take forms of electronic tags, which are embedded in the commodity packaging in a very small form. For another example, lightweight wearable devices may meet user needs while improving user experience.

Yet another example is the demand for extremely low-cost Internet of Things communication. Numerous Internet of Things communication scenarios require that cost of Internet of Things terminals be low enough to enhance their competitiveness relative to other alternative technologies. For example, in logistics or warehousing scenarios, in order to facilitate management of a large number of circulating items, each item may be attached with an Internet of Things terminal, so that accurate management of the entire logistics process and cycle may be completed through communication between this terminal and the logistics network. These scenarios require that prices of Internet of Things terminals be sufficiently competitive.

Therefore, in order to cover these unmet Internet of Things communication needs, it is also need to develop ultra-low-cost, extremely small-size, and battery-free/maintenance-free Internet of Things in cellular networks, and zero-power Internet of Things may just meet this need.

It should be pointed out that a zero-power Internet of Things may also be referred to as an ambient power enabled IoT, or an ambient IoT for short. Optionally, an ambient IoT device refers to an IoT device that uses various ambient powers, such as wireless radio frequency power, light power, solar power, thermal power, mechanical power, and other ambient powers. The ambient IoT device may have no power storage capability or may have very limited power storage capability (e.g., using capacitors with a capacity of tens of microfarads (μF)).

In some embodiments, the ambient IoT device may be used in at least the following four scenarios:
object recognition, such as logistics, production line product management, and supply chain management;
environmental monitoring, such as temperature, humidity, and harmful gas monitoring of working environment and natural environment;
positioning, such as indoor positioning, intelligent object search, production line item positioning, and the like; and
intelligent control, such as intelligent control of various electrical appliances in smart homes (turning on and off air conditioners, adjusting temperature), and intelligent control of various facilities in agricultural greenhouses (automatic irrigation and fertilization).

In order to facilitate better understanding of the embodiments of the present disclosure, inter modulation and cross modulation related to the present disclosure are explained.

The cross modulation refers to a modulation of a useful signal by a useless signal generated by an interaction of signals in nonlinear devices, network or communication media. Spectral components of one or more input signals interact with each other to produce new components whose frequencies are equal to a linear combination of integer multiples of frequencies of input signal components.

The inter modulation is a process that occurs in nonlinear devices or propagation media. Spectral components of one or more input signals interact with each other to produce new components whose frequencies are equal to a linear combination of integer multiples of frequencies of input signal components.

Optionally, in many cases, an input signal will generate harmonic components when passing through a nonlinear transmission network (nonlinear characteristics of RF devices). These harmonic components are integer multiples of a fundamental frequency f, such as 2f, 3f, 4f, etc. Generally speaking, at a relatively high frequency, the amplitude of these harmonics will gradually decrease.

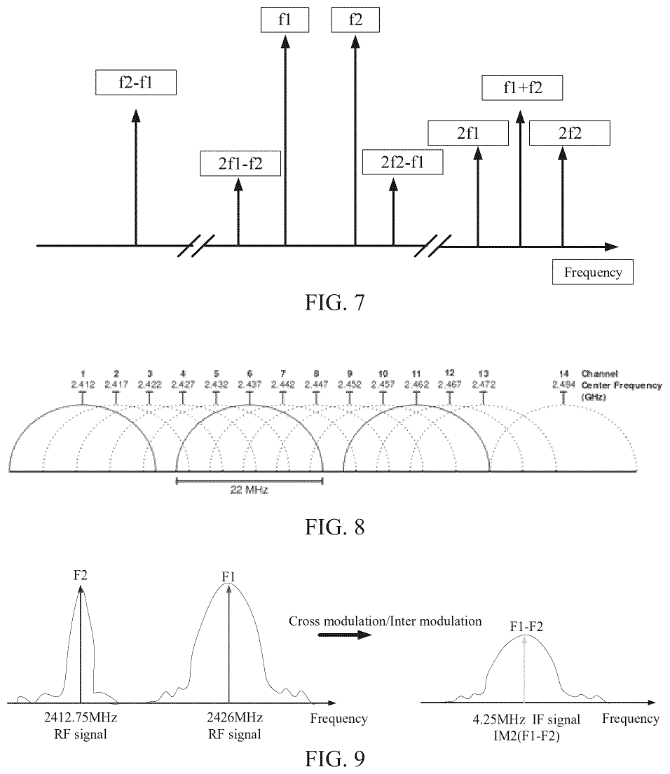

For example, when two radio frequency signals f1 and f2 pass through a passive device, inter modulation signals of 2/3/4/5/6/7 and so on orders will be generated. Frequencies 2f1, 2f2, (f1+f2) and (f2−f1) are products of second order inter modulation or intermodulation. As shown in FIG. 6, f1+f2 and f2−f1 are second order inter modulation products, which may be represented by IM2 (f2−f1) and IM2 (f1+f2). If the second order signal components 2f1 and 2f2 are mixed with first order signal components f1 and f2, new frequencies may be obtained, as shown in FIG. 7, and two third order cross modulation or inter modulation products are: (2f1−f2) and (2f2−f1).

In order to better understand the embodiments of the present disclosure, channels in the WiFi related to the present disclosure are described below.

Wi-Fi is a Wireless Local Area Network (WLAN) based on the IEEE 802.11 standard. There are many standard protocols for WLAN, such as IEEE 802.11 protocol family and HiperLAN protocol family.

A WLAN channel list shows wireless channels that IEEE 802.11 (or be referred to as WiFi) wireless network should use.

The 802.11 working group is divided into two separate frequency bands, i.e., 2.4 GHz and 4.9/5.8 GHz. Each frequency band is divided into several channels, and each country formulates its own policies on how to use these frequency bands, as shown in Table 1.

TABLE 1

| Country/Region | 2.4 GHz | 5 GHz (4.9/5.8) |
|---|---|---|
| China | 2.412 to 2.472 GHz: | 5.725 to 5.825 GHz: 4 |
| | 13 channels | channels |
| Americas (FCC) | 2.412 to 2.462 GHz: | 5.15 to 5.35 GHz, 5.725 to |
| | 11 channels | 5.825 GHz; 12 channels |
| North America | 2.412 to 2.462 GHz: | 5.15 to 5.35 GHz, 5.725 to |
| (Except FCC) | 11 channels | 5.825 GHz: 12 channels |
| Europe (ETSI) | 2.412 to 2.472 GHz: | 5.15 to 5.35 GHz: 8 channels |
| | 13 channels | 5470 to 5725 MHz: 11 |
| | | channels |
| Israel | 2.432 to 2.472 GHz: | 5.15 to 5.35 GHz: 8 channels |
| | 9 channels | |
| Japan | 2.412 to 2.472 GHz: | 2.412 to 2.484 GHz: |
| | 13 channels (OFDM) | 14 channels (CCK) |
| | | 5.15 to 5.25 GHz: 4 |
| | | channels |
| Japan 2 | 2.412 to 2.472 GHz: | CCK5.15 to 5.35 GHz: 8 |
| | 13 channels | channels |
| | OFDM 2.412 to 2.484 | |
| | GHz: 14 channels | |
| South Korea | 2.412 to 2.472 GHz: | 5.15 to 5.35 GHz, 5.46 to |
| | 13 channels | 5.72 GHz, 5.725 to |
| | | 5.825 GHz: 19 channels |
| Singapore | 2.412 to 2.472 GHz: | 5.15 to 5.35 GHz, 5.725 |
| | 13 channels | to 5.825 GHz: 12 channels |
| Taiwan, China | 2.412 to 2.462 GHz: | 5.25 to 5.35 GHz, 5.725 to |
| | 11 channels | 5.825 GHz: 7 channels |

An effective bandwidth of the channel is 20 MHz, and an actual bandwidth is 22 MHz, of which 2 MHz is an isolation band, as shown in FIG. 8.

Center frequency points of adjacent channels are spaced 5 MHz apart. There is frequency overlap among multiple adjacent channels. There are three groups of channels that do not interfere with each other (1, 6 and 11, or 2, 7 and 12, or 3, 8 and 13), as shown in Table 2.

TABLE 2

| Channel | Bandwidth (MHz) | Center frequency (MHz) |
|---|---|---|
| 1 | 20 | 2412 (2401 to 2423) |
| 2 | 20 | 2417 |
| 3 | 20 | 2422 |
| 4 | 20 | 2427 |
| 5 | 20 | 2432 |
| 6 | 20 | 2437 |
| 7 | 20 | 2442 |
| 8 | 20 | 2447 |
| 9 | 20 | 2453 |
| 10 | 20 | 2457 |
| 11 | 20 | 2463 |
| 12 | 20 | 2467 |
| 13 | 20 | 2472 |
| 14 (usually not used) | 20 | 2484 |

In order to facilitate better understanding of the embodiments of the present disclosure, problems solved by the present disclosure are described below.

An AMP device (also be referred to as a zero-power device or an ambient IoT device) has low complexity and low cost, and can be maintenance-free and battery-free. AMP devices may be divided into a passive zero-power terminal, a semi-passive zero-power terminal, and an active zero-power terminal, which harvest power in the environment (e.g., radio frequency power, light power, thermal power, mechanical power, and kinetic power) to obtain power for communication. In terms of communication manner, the AMP devices can support back scattering manner and/or active transmission communication manner.

Since the AMP devices need to be designed and implemented from the perspective of low complexity, low cost and low power consumption, they often cannot maintain relatively accurate timing, small frequency drift, time drift, or accurate local oscillation signals of required frequency for a long time, like a traditional terminal device (they cannot maintain frequency stability for a long time, and have frequency drift). How to obtain a local clock in a low-power and low-cost manner is an urgent problem that needs to be solved.

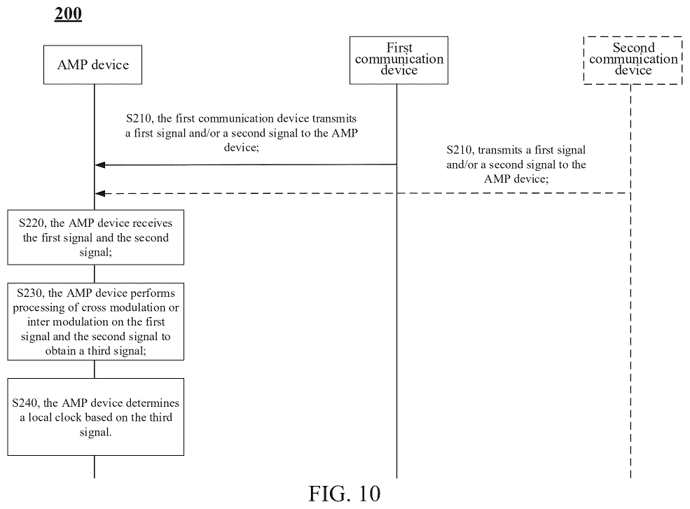

In light of the above problem, in some embodiments of the present disclosure, cross modulation/inter modulation of signals of different frequencies may be performed based on cross modulation/inter modulation principle. After extracting a frequency component signal, envelope detection is performed to obtain a required reference clock signal, and a local clock is obtained based on the reference clock signal (e.g., by using frequency multiplication). For example, when a transmitting end is transmitting signals, it simultaneously transmits a single-tone signal with a frequency of F1 and a single-tone signal with a frequency of F2, for example, F1>F2. The AMP device receives the two signals of F1 and F2, extracts frequency components after cross modulation/inter modulation, such as extracting a cross modulation/inter modulation signal of IM2 (F1−F2), as shown in FIG. 9, performs envelope detection on the IM2 signal to obtain a preliminary clock signal, and further obtains the local clock based on the clock signal (e.g., frequency multiplication may be performed). That is, in the embodiments of the present disclosure, the AMP device may determine the local clock based on an intermediate frequency signal obtained through the processing of cross modulation or inter modulation on two signals of different frequencies. The AMP device does not need to use a high-precision oscillator (e.g., a crystal oscillator, a numerically controlled oscillator, or the like) to generate the accurate local clock, and is capable of determining the local clock based on high-order components obtained by cross modulation or inter modulation of signals of different frequencies, which helps to reduce power consumption and cost of the AMP device.

In addition, how to transmit single-tone signals of different frequencies to enable the AMP device to perform inter modulation/cross modulation based on these two different single-tone signals to obtain the local clock is also a problem that needs to be solved urgently. In light of this problem, the present disclosure proposes a signal transmitting scheme, which may respectively transmit two signals (i.e., a first signal and a second signal) on two different candidate frequency domain resources; or respectively transmit two signals (i.e., a first signal and a second signal) on different frequency domain resources in a same candidate frequency domain resource, in which there is a guard period between frequency domain resources used to transmit the two signals (i.e., the first signal and the second signal).

To facilitate understanding of the technical solutions of the embodiments of the present disclosure, the technical solutions of the present disclosure are described in detail below through some embodiments. The following related art may be arbitrarily combined with the technical solutions of the embodiments of the present disclosure as optional solutions, and they all belong to the protection scope of the embodiments of the present disclosure. The embodiments of the present disclosure include at least part of the following contents.

FIG. 10 is a schematic flow chart of a wireless communication method 200 according to the embodiments of the present disclosure. As shown in FIG. 10, the wireless communication method 200 may include at least part of the following contents that:
in S210, a first communication device transmits a first signal and/or a second signal to an AMP device;
in S220, the AMP device receives the first signal and the second signal;
in S230, the AMP device performs processing of cross modulation or inter modulation on the first signal and the second signal to obtain a third signal; and
in S240, the AMP device determines a local clock based on the third signal.

It should be understood that FIG. 10 shows steps or operations of the wireless communication method 200, but these steps or operations are merely examples, and the embodiments of the present disclosure may further perform other operations or variations of the operations in FIG. 10.

In the embodiments of the present disclosure, the AMP device may also be referred to as a zero-power device or an ambient IoT device (A-IoT device), which has a simple structure, low complexity, and low cost. The AMP device can support power harvesting of ambient power (e.g., light power, thermal power, radio frequency power, mechanical power, and kinetic power) to obtain power required for communication, and may support a back scattering communication manner and/or an active transmission communication manner.

In the embodiments of the present disclosure, the AMP device may be applied to WiFi and/or cellular network.

In the embodiments of the present disclosure, the AMP device may determine the local clock based on the third signal obtained through the processing of cross modulation or inter modulation on the first signal and the second signal. The AMP device does not need to use a high-precision oscillator (e.g., a crystal oscillator, a numerically controlled oscillator, or the like) to generate the accurate local clock, and is capable of determining the local clock based on high-order components obtained by cross modulation or inter modulation of signals of different frequencies, which helps to reduce power consumption and cost of the AMP device.

In some embodiments, the above S240 may include:
performing, by the AMP device, envelope detection on the third signal, and obtaining or determining, by the AMP device, the local clock based on a signal after the envelope detection.

For example, the AMP device directly obtains the local clock based on the signal after envelope detection.

For another example, the AMP device performs frequency multiplication on the signal after envelope detection to obtain the local clock.

Optionally, the AMP device receives two single-tone RF signals (i.e., the first signal and the second signal) of different frequencies, performs cross modulation/inter modulation on these two signals, performs envelope detection based on a frequency component of the cross modulation/inter modulation (i.e., the third signal), such as IM2 (F1−F2), and obtains the local clock directly or indirectly based on a signal obtained after the envelope detection. Based on this, the AMP device does not need to use a high-precision oscillator (e.g., a crystal oscillator, a numerically controlled oscillator, or the like) to generate the accurate local clock, and is capable of determining the local clock based on high-order components obtained by cross modulation or inter modulation of signals of different frequencies, which helps to reduce power consumption and cost of the AMP device.

As an example, envelope detection is performed on the third signal (e.g., the IM2 signal) to obtain an initial clock signal, and the local clock is further obtained based on the initial clock signal. Optionally, frequency multiplication may be performed on the initial clock signal to obtain the local clock. For example, a desired clock frequency of the AMP device is 2.5 GHz. In this case, frequency multiplication is performed on an initial clock signal of 250 kHz to obtain a local clock of 2.5 GHz.

In some embodiments, the first signal and the second signal are transmitted by a same device, or the first signal and the second signal are transmitted by different devices.

In some embodiments, in a case where the first communication device transmits the first signal and the second signal, the first communication device is one of: an access point (AP), a station (STA), a base station, a terminal device, and a transmission reception point (TRP).

In some embodiments, in a case where the first communication device transmits only the first signal, the second signal is transmitted to the AMP device by a second communication device triggered by the first communication device, as shown in FIG. 10. Of course, the second signal may also be actively transmitted by the second communication device, which is not limited in the embodiments of the present disclosure. Optionally, the first communication device is one of: an access point (AP), a station (STA), a base station, a terminal device, a relay device, and a TRP. Optionally, the second communication device is one of: an access point (AP), a station (STA), a base station, a terminal device, a relay device, a TRP, a power supply device of an AMP device, a dedicated device, and a third-party device.

In some embodiments, in a case where the first communication device transmits only the second signal, the second signal is transmitted to the AMP device after being triggered by the second communication device, as shown in FIG. 10. Of course, the second signal may also be actively transmitted by the first communication device, which is not limited in the embodiments of the present disclosure. Optionally, the first communication device is one of: an access point (AP), a station (STA), a base station, a terminal device, a relay device, a TRP, a power supply device of an AMP device, a dedicated device, and a third-party device. Optionally, the second communication device is one of: an access point (AP), a station (STA), a base station, a terminal device, a relay device, and a TRP.

In some embodiments, the first signal is a reference radio frequency signal or a dedicated frequency modulation signal. Of course, the first signal may also be any of other signals, which is not limited in the present disclosure.

In some embodiments, the second signal is a reference radio frequency signal or a dedicated frequency modulation signal. Of course, the second signal may also be any of other signals, which is not limited in the present disclosure.

In some embodiments, the third signal is an intermediate frequency (IF) signal. Optionally, the third signal is associated with high-order components (greater than or equal to second-order, such as second-order components, third-order components, fourth-order components, or other higher-order components) obtained after processing of cross modulation or inter modulation on the first signal and the second signal.

As an example, the AMP device may directly extract the high-order components obtained after processing of cross modulation or inter modulation on the first signal and the second signal, for example, the high-order components such as IM2 (F_{first signal}−F_{second signal}), IM2 (F_{second signal}−F_{first signal}), and IM3 (2F_{first signal}−F_{second signal}) are used as the third signal (e.g., an IF signal).

As an example, the AMP device obtains the high-order components obtained after processing of cross modulation or inter modulation on the first signal and the second signal, and performs frequency conversion on the high-order components obtained after processing of cross modulation or inter modulation on the first signal and the second signal to obtain the third signal (e.g., an IF signal). Optionally, the AMP device may perform frequency conversion on the high-order components obtained after processing of cross modulation or inter modulation on the first signal and the second signal through an artificial intelligence (AI) model to obtain the third signal (e.g., an IF signal).

For example, the AMP device extracts the high-order components (i.e., the third signal) after cross modulation or inter modulation, performs envelope detection on the third signal, and further processes the signal after the envelope detection (e.g., frequency multiplication) to obtain the local clock signal.

In some embodiments, the first signal is a single-frequency point signal, or the first signal is a multi-frequency point signal. For example, the first signal is a radio frequency signal (RF signal).

In some embodiments, the second signal is a single-frequency point signal, or the second signal is a multi-frequency point signal. For example, the second signal is a radio frequency signal (RF signal).

Optionally, in the embodiments of the present disclosure, the frequency point may be a subcarrier (subcarrier/tone). That is, in the embodiments of the present disclosure, the first signal and/or the second signal is a single subcarrier signal (single tone RF signal/single subcarrier RF signal), or the first signal and/or the second signal is a multiple subcarrier signal (multiple tone RF signal/multiple subcarrier RF signal).

For example, the first signal and the second signal are both single-tone RF signals.

In some embodiments, the first signal is a narrowband signal with a bandwidth less than or equal to a preset value, and/or the second signal is a narrowband signal with a bandwidth less than or equal to a preset value. Optionally, the preset value is agreed upon by a protocol, or the preset value is configured (semi-statically or dynamically) by a network device (e.g., an AP or a base station or a TRP), or the preset value is determined based on information reported by the AMP device.

In some embodiments, the AMP device performs power harvesting based on the first signal and/or the second signal.

In some embodiments, the first signal is a periodically transmitted signal. Optionally, periodic information for transmitting the first signal may be agreed upon by a protocol, or the periodic information for transmitting the first signal may be configured (semi-statically or dynamically) by a network device (e.g., an AP or a base station or a TRP), or the periodic information for transmitting the first signal may be determined based on information reported by the AMP device.

In some embodiments, the second signal is a periodically transmitted signal. Optionally, periodic information for transmitting the second signal may be agreed upon by a protocol, or the periodic information for transmitting the second signal may be configured (semi-statically or dynamically) by a network device (e.g., an AP or a base station or a TRP), or the periodic information for transmitting the second signal may be determined based on information reported by the AMP device.

In some embodiments, the first signal is a signal transmitted based on an event trigger. For example, in a case where a transmitting end device needs to communicate with the AMP device, the first signal is transmitted.

In some embodiments, the second signal is a signal transmitted based on an event trigger. For example, in a case where a transmitting end device needs to communicate with the AMP device, the second signal is transmitted.

In some embodiments, the first signal is a signal transmitted in bundling with the second signal (i.e., they exist simultaneously).

In some embodiments, the first signal and/or the second signal is a continuously transmitted signal.

In some embodiments, a center frequency point of the first signal is different from a center frequency point of the second signal; and/or a center frequency point of a frequency domain resource used for transmission of the first signal is different from a center frequency point of a frequency domain resource used for transmission of the second signal.

In some embodiments, the candidate frequency domain resource is one of: a channel, a system bandwidth, a carrier bandwidth, a band width part (BWP), an aggregation/collection/bundling of a plurality of BWPs, an aggregation/collection/bundling of a plurality of subcarriers (subcarriers/tones), and an aggregation/collection/bundling of a plurality of physical resource blocks (PRBs).

In some embodiments, the frequency domain resource used for transmission of the first signal is a candidate frequency domain resource, or the frequency domain resource used for transmission of the first signal is a partial frequency domain resource in a candidate frequency domain resource. For example, the candidate frequency domain resource is a channel, and the frequency domain resource used for transmission of the first signal is some subcarriers in the channel.

In some embodiments, the frequency domain resource used for transmission of the second signal is a candidate frequency domain resource, or the frequency domain resource used for transmission of the second signal is a partial frequency domain resource in a candidate frequency domain resource. For example, the candidate frequency domain resource is a channel, and the frequency domain resource used for transmission of the second signal is one or more subcarriers in the channel.

In some embodiments, within a deployment frequency band corresponding to the AMP device, different candidate frequency domain resources do not overlap, or different candidate frequency domain resources partially overlap.

Optionally, the AMP device may be applied to a cellular system or a WiFi system. Within the deployment working frequency band of the AMP device, a plurality of channels or carriers may often be generated through division, and different channels may overlap or not overlap. The first communication device may transmit the first signal and the second signal on the same or two different candidate frequency domain resources on its working frequency band. Correspondingly, the AMP device may receive the first signal and the second signal on the same or two different candidate frequency domain resources on its working frequency band, and obtain the third signal (i.e., an IF signal corresponding to the first signal) directly or indirectly through cross modulation/inter modulation, thereby determining the local clock.

For example, in a case where an RFID frequency band of 920 to 925 MHz is used by the AMP device for communication, if a bandwidth of each channel is 250 kHz, a system bandwidth of 5 MHz (920 to 925 MHz) may be divided into 20 channels with a bandwidth of 250 kHz. In this case, the candidate frequency domain resource may be a channel, that is, each channel serves as a candidate frequency domain resource, and the AMP device may receive the first signal and the second signal on different channels.

In some embodiments, the candidate frequency domain resource used for transmission of the first signal is different from the candidate frequency domain resource used for transmission of the second signal, or the candidate frequency domain resource used for transmission of the first signal is the same as the candidate frequency domain resource used for transmission of the second signal.

In some embodiments, in a case where the candidate frequency domain resource used for transmission of the first signal is different from the candidate frequency domain resource used for transmission of the second signal, all candidate frequency domain resources within the deployment frequency band corresponding to the AMP device include m first-type candidate frequency domain resources and n second-type candidate frequency domain resources, where a first-type candidate frequency domain resource is a candidate frequency domain resource available for transmitting the first signal, and a second-type candidate frequency domain resource is a candidate frequency domain resource available for transmitting the second signal, and m and n are both positive integers.

For example, m=1, 2, 3, . . . ; and/or n=1, 2, 3, . . . .

As an example, in a case where an RFID frequency band of 920 to 925 MHz is used for communication, if a bandwidth of each channel is 250 kHz, a system bandwidth of 5 MHz (920 to 925 MHz) may be divided into 20 channels with a bandwidth of 250 kHz. In this case, the candidate frequency domain resource may refer to each channel of 250 kHz, that is, each channel is used as a candidate frequency domain resource, and a transmitting end transmits the first signal and the second signal on two different channels respectively. For example, the same transmitting end transmits two RF signals (i.e., the first signal and the second signal), or two transmitting ends transmit two RF signals (i.e., the first signal and the second signal) respectively.

In some embodiments, the first-type candidate frequency domain resource within the deployment frequency band corresponding to the AMP device are not available for transmitting signals other than the first signal. Therefore, reliable transmission of the first signal may be guaranteed.

In some embodiments, the second-type candidate frequency domain resource within the deployment frequency band corresponding to the AMP device are not available for transmitting signals other than the second signal. Therefore, reliable transmission of the second signal may be guaranteed.

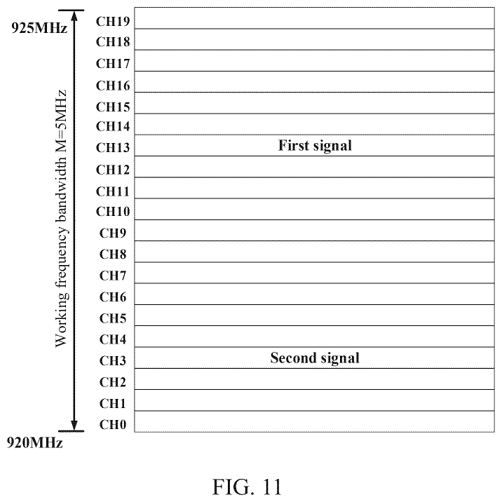

Optionally, in a case where an RFID frequency band of 920 to 925 MHz is used for communication, if a bandwidth of each channel is 250 kHz, a system bandwidth of 5 MHz (920 to 925 MHz) may be divided into 20 channels (CHs) with a bandwidth of 250 kHz, as shown in FIG. 11. CH13 is used by a transmitting end device to transmit the first signal to the AMP device, and CH3 is used by the transmitting end device to transmit the second signal to the AMP device.

In some embodiments, an interval between the center frequency point of the candidate frequency domain resource used for transmission of the first signal and the center frequency point of the candidate frequency domain resource used for transmission of the second signal is greater than or equal to X₁ frequency domain units, and/or an interval between the center frequency point of the first signal and the center frequency point of the second signal is greater than or equal to X₁ frequency domain units, where X₁ is a positive integer.

As an example, in a case where m=1 and n=1, the interval between the center frequency point of the candidate frequency domain resource used for transmission of the first signal and the center frequency point of the candidate frequency domain resource used for transmission of the second signal is greater than or equal to X₁ frequency domain units, and/or the interval between the center frequency point of the first signal and the center frequency point of the second signal is greater than or equal to X₁ frequency domain units, where X₁ is a positive integer.

In some embodiments, a frequency domain unit in the X₁ frequency domain units is one of: a candidate frequency domain resource, a channel, a system bandwidth, a carrier, a subcarrier, a PRB, a BWP, a megahertz (MHz), a kilohertz (kHz), and a hertz (Hz).

In some embodiments, the X₁ frequency domain units are agreed upon by a protocol, or the X₁ frequency domain units are configured (semi-statically or dynamically) by a network device (e.g., an AP or a base station or a TRP), or the X₁ frequency domain units are determined based on a clock frequency factor reported by the AMP device.

Optionally, the clock frequency factor reported by the AMP device may be an expected clock frequency factor of the AMP device. For example, an expected clock frequency of the AMP device is 100 MHz, and a clock frequency factor of 100 MHz may be 20, 25, 50, or the like. Then a difference between two signals (i.e., the first signal and the second signal) may be the clock frequency factor of 100 MHz, for example, 20 MHz. In this way, a third signal of 20 MHz is first generated through cross modulation or inter modulation, and then frequency multiplication is performed on the third signal.

For example, X₁ frequency domain units are expected clock frequency factors of the AMP device. Taking the above channels as an example, where a bandwidth of each channel is 250 kHz, if two adjacent channels are used by first signal and the second signal, and a middle position in each of these channels is used to transmit the signal, an interval between the two signals is 250 kHz, and the expected clock frequency of the AMP device is 2.5 GHz. In this case, frequency multiplication may be performed on an initial clock signal of 250 kHz to obtain a clock signal of 2.5 GHz.

In some embodiments, the deployment frequency band corresponding to the AMP device includes a plurality of groups of bound candidate frequency domain resources; where each group of bound candidate frequency domain resources in the plurality of groups of bound candidate frequency domain resources includes at least one of the first-type candidate frequency domain resources and at least one of the second-type candidate frequency domain resources.

As an example, in a case where m≥2 and n≥2, the deployment frequency band corresponding to the AMP device includes a plurality of groups of bound candidate frequency domain resources; where each group of bound candidate frequency domain resources in the plurality of groups of bound candidate frequency domain resources includes at least one of the first-type candidate frequency domain resources and at least one of the second-type candidate frequency domain resources.

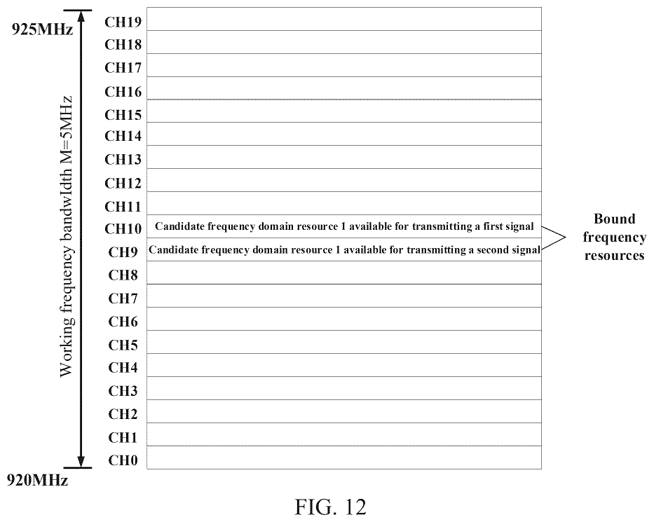

Optionally, in a case where an RFID frequency band of 920 to 925 MHz is used for communication, if a bandwidth of each channel is 250 kHz, a system bandwidth of 5 MHz (920 to 925 MHz) may be divided into 20 channels (CHs) with a bandwidth of 250 kHz, as shown in FIG. 12. The frequency domain resource available for transmitting the first signal is CH10 (i.e., the first-type candidate frequency domain resource is CH10), and the frequency domain resource available for transmitting the second signal is CH9 (i.e., the second-type candidate frequency domain resource is CH9), where CH9 available for transmitting the second signal and CH10 available for transmitting the first signal are two different bound channels.

In some embodiments, the plurality of groups of bound candidate frequency domain resources are agreed upon by a protocol, or the plurality of groups of bound candidate frequency domain resources are configured (semi-statically or dynamically) by a network device (e.g., an AP or a base station or a TRP), or the plurality of groups of bound candidate frequency domain resources are determined based on information reported by the AMP device.

In some embodiments, in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

In some embodiments, in each group of bound candidate frequency domain resources in the plurality of groups of bound candidate frequency domain resources, a first-type candidate frequency domain resource is adjacent to a second-type candidate frequency domain resource, or the first-type candidate frequency domain resource is not adjacent to the second-type candidate frequency domain resource.

As an example, each group of bound candidate frequency domain resources includes two different bound channels, which may be two adjacent channels or two non-adjacent channels.

In some embodiments, in each group of bound candidate frequency domain resources in the plurality of groups of bound candidate frequency domain resources, a first-type candidate frequency domain resource and a second-type candidate frequency domain resource meet a preset relationship. Optionally, the preset relationship may be agreed upon by a protocol, or the preset relationship may be configured (semi-statically or dynamically) by a network device (e.g., an AP or a base station or a TRP).

In some embodiments, in each group of bound candidate frequency domain resources in the plurality of groups of bound candidate frequency domain resources, the first-type candidate frequency domain resource and the second-type candidate frequency domain resource meet the following formula 1:

$$F 1 = F 2 + Δ F ; \qquad Formula 1$$

where F1 represents the first-type candidate frequency domain resource, F2 represents the second-type candidate frequency domain resource, and ΔF represents a frequency domain interval.

Optionally, ΔF may be agreed upon by a protocol, or ΔF may be configured (semi-statically or dynamically) by a network device (e.g., an AP or a base station or a TRP).

In some embodiments, the m first-type candidate frequency domain resources are configured (semi-statically or dynamically) by a network device (e.g., an AP or a base station or a TRP). Optionally, a configuration granularity of the m first-type candidate frequency domain resources includes one of: an AMP granularity, an AMP group granularity, and a cell granularity. For example, in a case where the configuration granularity of the m first-type candidate frequency domain resources is the cell granularity, the m first-type candidate frequency domain resources are configured by broadcasting.

In some embodiments, the m first-type candidate frequency domain resources are preempted and indicated to the AMP device by the network device (e.g., an AP or a base station or a TRP).

In some embodiments, the m first-type candidate frequency domain resources are determined based on information reported by the AMP device.

In some embodiments, the m first-type candidate frequency domain resources are associated with at least one of: an identifier of the AMP device, or an identifier of an AMP group to which the AMP device belongs.

For example, assuming that the deployment frequency band corresponding to the AMP device contains W candidate frequency domain resources, the first-type candidate frequency domain resource is determined based on ID mod W, where ID is an identifier of the AMP device, or ID is an identifier of an AMP group to which the AMP device belongs, or ID is an identifier determined based on the identifier of the AMP device and the identifier of the AMP group to which the AMP device belongs (an identifier obtained by intercepting partial fields of the identifier of the AMP device and the identifier of the AMP group to which the AMP device belongs).

In some embodiments, a frequency domain resource in the first-type candidate frequency domain resource that is available for transmitting the first signal is configured (semi-statically or dynamically) by a network device (e.g., an AP or a base station or a TRP), or the frequency domain resource in the first-type candidate frequency domain resource that is available for transmitting the first signal is agreed upon by a protocol, or the frequency domain resource in the first-type candidate frequency domain resource that is available for transmitting the first signal is determined based on information reported by the AMP device.

As an example, the first-type candidate frequency domain resource is a channel, and the frequency domain resource available for transmitting the first signal is one subcarrier/tone. For example, the frequency domain resource available for transmitting the first signal may be located at an upper side, a middle position, a lower side, a position agreed upon by a protocol, or the like of the channel.

In some embodiments, in a case where the frequency domain resource in the first-type candidate frequency domain resource that is available for transmitting the first signal is configured by a network device, a configuration granularity of the frequency domain resource in the first-type candidate frequency domain resource that is available for transmitting the first signal includes one of: an AMP granularity, an AMP group granularity, and a cell granularity.

In some embodiments, the n second-type candidate frequency domain resources are agreed upon by a protocol.

In some embodiments, the n second-type candidate frequency domain resources are configured (semi-statically or dynamically) by a network device (e.g., an AP or a base station or a TRP). Optionally, a configuration granularity of the n second-type candidate frequency domain resources includes one of: an AMP granularity, an AMP group granularity, and a cell granularity. For example, in a case where the configuration granularity of the n second-type candidate frequency domain resources is the cell granularity, the n second-type candidate frequency domain resources are configured by broadcasting.

In some embodiments, the n second-type candidate frequency domain resources are determined based on information reported by the AMP device.

In some embodiments, the n second-type candidate frequency domain resources are preempted and indicated to the AMP device by the network device.

In some embodiments, a frequency domain resource in a second-type candidate frequency domain resource that is available for transmitting the second signal is configured (semi-statically or dynamically) by a network device (e.g., an AP or a base station or a TRP), or the frequency domain resource in the second-type candidate frequency domain resource that is available for transmitting the second signal is agreed upon by a protocol, or the frequency domain resource in the second-type candidate frequency domain resource that is available for transmitting the second signal is determined based on information reported by the AMP device.

As an example, the second-type candidate frequency domain resource is a channel, and the frequency domain resource available for transmitting the second signal is one subcarrier/tone. For example, the frequency domain resource available for transmitting the second signal may be located at an upper side, a middle position, a lower side, a position agreed upon by a protocol, or the like of the channel.

In some embodiments, in a case where the frequency domain resource in the second-type candidate frequency domain resource that is available for transmitting the second signal is configured by a network device, a configuration granularity of the frequency domain resource in the second-type candidate frequency domain resource that is available for transmitting the second signal includes one of: an AMP granularity, an AMP group granularity, and a cell granularity. For example, in a case where the configuration granularity of the frequency domain resource in the second-type candidate frequency domain resource that is available for transmitting the second signal is the cell granularity, the frequency domain resource in the second-type candidate frequency domain resource that is available for transmitting the second signal is configured by broadcasting.

In some embodiments, a candidate frequency domain resource available for transmitting the first signal is shared by different AMP devices, and/or a candidate frequency domain resource available for transmitting the second signal is shared by different AMP devices.

In some embodiments, different candidate frequency domain resources available for transmitting the first signal are used by different AMP devices, and/or different candidate frequency domain resources available for transmitting the second signal are used by different AMP devices.

For example, the candidate frequency domain resource available for transmitting the first signal is shared by different AMP devices, and the candidate frequency domain resource available for transmitting the second signal is shared by different AMP devices.

For another example, different candidate frequency domain resources available for transmitting the first signal are used by different AMP devices, and/or different candidate frequency domain resources available for transmitting the second signal are used by different AMP devices.

For yet another example, the candidate frequency domain resource available for transmitting the first signal is shared by different AMP devices, and different candidate frequency domain resources available for transmitting the second signal are used by different AMP devices.

For still another example, different candidate frequency domain resources available for transmitting the first signal are used by different AMP devices, and the candidate frequency domain resource available for transmitting the second signal is shared by different AMP devices.

In some embodiments, in a case where the candidate frequency domain resource available for transmitting the first signal is shared by different AMP devices, the different AMP devices transmit the first signal using frequency division multiplexing (FDM).

In some embodiments, in a case where the candidate frequency domain resource available for transmitting the second signal is shared by different AMP devices, the different AMP devices transmit the second signal using FDM.

In some embodiments, in a case where the candidate frequency domain resource used for transmission of the first signal is the same as the candidate frequency domain resource used for transmission of the second signal, all candidate frequency domain resources within the deployment frequency band corresponding to the AMP device include s third-type candidate frequency domain resources, where a third-type candidate frequency domain resource is a candidate frequency domain resource available for transmitting the first signal and the second signal, and s is a positive integer. For example, s=1, 2, 3, . . . .

In some embodiments, a frequency domain resource in the third-type candidate frequency domain resource that is available for transmitting the first signal is different from a frequency domain resource in the third-type candidate frequency domain resource that is available for transmitting the second signal.

In some embodiments, an interval between a frequency domain resource in the third-type candidate frequency domain resource that is available for transmitting the first signal and a frequency domain resource in the third-type candidate frequency domain resource that is available for transmitting the second signal is greater than or equal to X₂ frequency domain units, where X₂ is a positive integer.

In some embodiments, the frequency domain unit in the X₂ frequency domain units is one of: a channel, a system bandwidth, a carrier, a subcarrier, a PRB, a BWP, a MHz, a kHz, and a Hz.

In some embodiments, the X₂ frequency domain units are agreed upon by a protocol, or the X₂ frequency domain units are configured (semi-statically or dynamically) by a network device (e.g., an AP or a base station or a TRP), or the X₂ frequency domain units are determined based on a clock frequency factor reported by the AMP device. Optionally, the clock frequency factor reported by the AMP device may be an expected clock frequency factor of the AMP device.

In some embodiments, there are guard periods on both sides of a frequency domain resource in the third-type candidate frequency domain resource that is available for transmitting the first signal, where the guard periods are not available for transmitting a radio frequency signal therein. Optionally, the guard periods may be the X₂ frequency domain units, or the guard periods may be less than the X₂ frequency domain units. This may avoid interference from transmission of other radio frequency signals to transmission of the first signal, thereby ensuring the reliable transmission of the first signal.

In some embodiments, there are guard periods on both sides of a frequency domain resource in the third-type candidate frequency domain resource that is available for transmitting the second signal, where the guard periods are not available for transmitting a radio frequency signal therein. Optionally, the guard periods may be the X₂ frequency domain units, or the guard periods may be less than the X₂ frequency domain units. This may avoid interference from transmission of other radio frequency signals to transmission of the second signal, thereby ensuring the reliable transmission of the second signal.

In some embodiments, sizes of the guard periods on both sides of the frequency domain resource in the third-type candidate frequency domain resource that is available for transmitting the first signal are equal, or the sizes of the guard periods on both sides of the frequency domain resource in the third-type candidate frequency domain resource that is available for transmitting the first signal are unequal. Therefore, the guard periods on both sides of the frequency domain resource available for transmitting the first signal may be set more flexibly.

In some embodiments, sizes of the guard periods on both sides of the frequency domain resource in the third-type candidate frequency domain resource that is available for transmitting the second signal are equal, or the sizes of the guard periods on both sides of the frequency domain resource in the third-type candidate frequency domain resource that is available for transmitting the second signal are unequal. Therefore, the guard periods on both sides of the frequency domain resource available for transmitting the second signal may be set more flexibly.

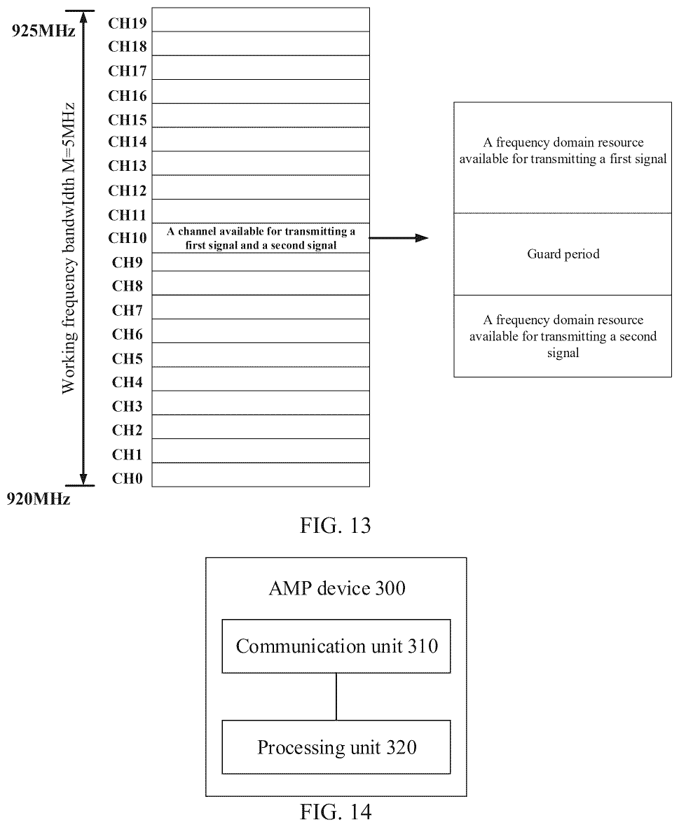

Optionally, in a case where an RFID frequency band of 920 to 925 MHz is used for communication, if a bandwidth of each channel is 250 kHz, a system bandwidth of 5 MHz (920 to 925 MHz) may be divided into 20 channels (CHs) with a bandwidth of 250 kHz. As shown in FIG. 13, the candidate frequency domain resource available for transmitting the first signal and the second signal is CH10 (i.e., the third-type candidate frequency domain resource is CH10). In CH10, there is a guard period (GAP) between the frequency domain resource available for transmitting the first signal and the frequency domain resource available for transmitting the second signal.

In some embodiments, the third-type candidate frequency domain resource includes a plurality of groups of bound frequency domain resources;
where in each group of bound frequency domain resources in the plurality of groups of bound frequency domain resources includes at least one frequency domain resource available for transmitting the first signal and at least one frequency domain resource available for transmitting the second signal.

In some embodiments, the plurality of groups of bound frequency domain resources are agreed upon by a protocol, or the plurality of groups of bound frequency domain resources are configured by a network device, or the plurality of groups of bound frequency domain resources are determined based on information reported by the AMP device, or the plurality of groups of bound frequency domain resources are associated with at least one of: an identifier of the AMP device, or an identifier of an AMP group to which the AMP device belongs.

For example, assuming that the third-type candidate frequency domain resource includes Q frequency domain resources, the plurality of groups of bound frequency domain resources are determined based on ID mod Q, where ID is an identifier of the AMP device, or ID is an identifier of an AMP group to which the AMP device belongs, or ID is an identifier determined based on the identifier of the AMP device and the identifier of the AMP group to which the AMP device belongs (an identifier obtained by intercepting partial fields of the identifier of the AMP device and the identifier of the AMP group to which the AMP device belongs).

In some embodiments, in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

In some embodiments, the s third-type candidate frequency domain resources are configured (semi-statically or dynamically) by a network device (e.g., an AP or a base station or a TRP).

In some embodiments, the s third-type candidate frequency domain resources are determined based on information reported by the AMP device.

In some embodiments, the s third-type candidate frequency domain resources are preempted and indicated to the AMP device by the network device.

In some embodiments, in a case where the s third-type candidate frequency domain resources are preempted and indicated to the AMP device by the network device, the third-type candidate frequency domain resources are successfully preempted in response to that: there is no interference on a frequency domain resource in the third-type candidate frequency domain resource that is available for transmitting the first signal, there is no interference on a frequency domain resource in the third-type candidate frequency domain resource that is available for transmitting the second signal, and there is no interference between the frequency domain resource in the third-type candidate frequency domain resource that is available for transmitting the first signal and the frequency domain resource in the third-type candidate frequency domain resource that is available for transmitting the second signal.

In some embodiments, in a case where the s third-type candidate frequency domain resources are preempted and indicated to the AMP device by the network device, the network device may preempt a resource through a scheme similar to a transmission opportunity (TXOP) mechanism.

In some embodiments, in a case where the s third-type candidate frequency domain resources are preempted and indicated to the AMP device by the network device, the third-type candidate frequency domain resource and a candidate frequency domain resource adjacent thereto are both preempted by the network device, or only the third-type candidate frequency domain resource is preempted by the network device.

In some embodiments, a frequency domain resource in the third-type candidate frequency domain resource that is available for transmitting the first signal is configured (semi-statically or dynamically) by a network device (e.g., an AP or a base station or a TRP), or the frequency domain resource in the third-type candidate frequency domain resource that is available for transmitting the first signal is agreed upon by a protocol, or the frequency domain resource in the third-type candidate frequency domain resource that is available for transmitting the first signal is determined based on information reported by the AMP device.

As an example, the third-type candidate frequency domain resource is a channel, and the frequency domain resource available for transmitting the first signal is one subcarrier/tone. For example, the frequency domain resource available for transmitting the first signal may be located at an upper side, a middle position, a lower side, a position agreed upon by a protocol, or the like of the channel.

In some embodiments, a frequency domain resource in the third-type candidate frequency domain resource that is available for transmitting the second signal is configured (semi-statically or dynamically) by a network device (e.g., an AP or a base station or a TRP), or the frequency domain resource in the third-type candidate frequency domain resource that is available for transmitting the second signal is agreed upon by a protocol, or the frequency domain resource in the third-type candidate frequency domain resource that is available for transmitting the second signal is determined based on information reported by the AMP device.

As an example, the third-type candidate frequency domain resource is a channel, and the frequency domain resource available for transmitting the second signal is one subcarrier/tone. For example, the frequency domain resource available for transmitting the second signal may be located at an upper side, a middle position, a lower side, a position agreed upon by a protocol, or the like of the channel.

In some embodiments, the frequency domain resource in the third-type candidate frequency domain resource that is available for transmitting the first signal is located before the frequency domain resource available for transmitting the second signal, or the frequency domain resource in the third-type candidate frequency domain resource that is available for transmitting the first signal is located after the frequency domain resource available for transmitting the second signal.

In some embodiments, in a case where the frequency domain resource in the third-type candidate frequency domain resource that is available for transmitting the first signal is configured by a network device, a configuration granularity of the frequency domain resource in the third-type candidate frequency domain resource that is available for transmitting the first signal includes one of: an AMP granularity, an AMP group granularity, and a cell granularity. For example, in a case where the configuration granularity of the frequency domain resource in the third-type candidate frequency domain resource that is available for transmitting the first signal is the cell granularity, the frequency domain resource in the third-type candidate frequency domain resource that is available for transmitting the first signal is configured by broadcasting.

In some embodiments, in a case where the frequency domain resource in the third-type candidate frequency domain resource that is available for transmitting the second signal is configured by a network device, a configuration granularity of the frequency domain resource in the third-type candidate frequency domain resource that is available for transmitting the second signal includes one of: an AMP granularity, an AMP group granularity, and a cell granularity. For example, in a case where the configuration granularity of the frequency domain resource in the third-type candidate frequency domain resource that is available for transmitting the second signal is the cell granularity, the frequency domain resource in the third-type candidate frequency domain resource that is available for transmitting the second signal is configured by broadcasting.

In some embodiments, a candidate frequency domain resource available for transmitting the first signal is shared by different AMP devices, and/or a candidate frequency domain resource available for transmitting the second signal is shared by different AMP devices.

In some embodiments, different candidate frequency domain resources available for transmitting the first signal are used by different AMP devices, and/or different candidate frequency domain resources available for transmitting the second signal are used by different AMP devices.

For example, the candidate frequency domain resource available for transmitting the first signal is shared by different AMP devices, and the candidate frequency domain resource available for transmitting a second signal is shared by different AMP devices.

For another example, different candidate frequency domain resources available for transmitting the first signal are used by different AMP devices, and/or different candidate frequency domain resources available for transmitting the second signal are used by different AMP devices.

For yet another example, the candidate frequency domain resource available for transmitting the first signal is shared by different AMP devices, and different candidate frequency domain resources available for transmitting the second signal are used by different AMP devices.

For still another example, different candidate frequency domain resources available for transmitting the first signal are used by different AMP devices, and candidate frequency domain resource available for transmitting the second signal is shared by different AMP devices.

In some embodiments, in a case where the candidate frequency domain resource available for transmitting the first signal is shared by different AMP devices, the different AMP devices transmit the first signal using FDM.

In some embodiments, in a case where the candidate frequency domain resource available for transmitting the second signal is shared by different AMP devices, the different AMP devices transmit the second signal using FDM.

Therefore, in the embodiments of the present disclosure, the AMP device may determine the local clock based on the third signal obtained through the processing of cross modulation or inter modulation on the first signal and the second signal. The AMP device does not need to use a high-precision oscillator (e.g., a crystal oscillator, a numerically controlled oscillator, or the like) to generate the accurate local clock, and is capable of determining the local clock based on high-order components obtained by cross modulation or inter modulation of signals of different frequencies, which helps to reduce power consumption and cost of the AMP device.

That is, in the embodiments of the present disclosure, the AMP device receives two single-tone RF signals of different frequencies, performs cross modulation/inter modulation on these two signals, performs envelope detection based on a frequency component of the cross modulation/inter modulation, such as IM2 (F1−F2), and obtains the local clock directly or indirectly. Based on the solution in the embodiments of the present disclosure, the AMP device does not need to use a high-precision oscillator (e.g., a crystal oscillator, a numerically controlled oscillator, or the like) to generate the accurate local clock, and is capable of determining the local clock based on high-order components obtained by cross modulation or inter modulation of signals of different frequencies, which helps to reduce power consumption and cost of the AMP device.

The above, in combination with FIGS. 10 to 13, describes in detail the method embodiments of the present disclosure. The following, in combination with FIGS. 14 to 18, describes in detail the device/apparatus embodiments of the present disclosure. It should be understood that the device/apparatus embodiments and the method embodiments correspond to each other, and similar descriptions may refer to the method embodiments.

FIG. 14 shows a schematic block diagram of an ambient power (AMP) device 300 in accordance with the embodiments of the present disclosure. As shown in FIG. 14, the AMP device 300 includes:
a communication unit 310, configured to receive a first signal and a second signal; and
a processing unit 320, configured to perform processing of cross modulation or inter modulation on the first signal and the second signal to obtain a third signal;
where the processing unit 320 is further configured to determine a local clock based on the third signal.

In some embodiments, a center frequency point of the first signal is different from a center frequency point of the second signal; and/or a center frequency point of a frequency domain resource used for transmission of the first signal is different from a center frequency point of a frequency domain resource used for transmission of the second signal.

In some embodiments, the frequency domain resource used for transmission of the first signal is a candidate frequency domain resource, or the frequency domain resource used for transmission of the first signal is a partial frequency domain resource in a candidate frequency domain resource; and/or
the frequency domain resource used for transmission of the second signal is a candidate frequency domain resource, or the frequency domain resource used for transmission of the second signal is a partial frequency domain resource in a candidate frequency domain resource.

In some embodiments, the candidate frequency domain resource used for transmission of the first signal is different from the candidate frequency domain resource used for transmission of the second signal, or the candidate frequency domain resource used for transmission of the first signal is the same as the candidate frequency domain resource used for transmission of the second signal.

In some embodiments, in a case where the candidate frequency domain resource used for transmission of the first signal is different from the candidate frequency domain resource used for transmission of the second signal, all candidate frequency domain resources within a deployment frequency band corresponding to the AMP device include m first-type candidate frequency domain resource and n second-type candidate frequency domain resource, where a first-type candidate frequency domain resource is a candidate frequency domain resource available for transmitting the first signal, and a second-type candidate frequency domain resource is a candidate frequency domain resource available for transmitting the second signal, where m and n are both positive integers.

In some embodiments, the first-type candidate frequency domain resource within the deployment frequency band corresponding to the AMP device is not available for transmitting signals other than the first signal, and/or the second-type candidate frequency domain resource within the deployment frequency band corresponding to the AMP device is not available for transmitting signals other than the second signal.

In some embodiments, in a case where m=1 and n=1, an interval between the first-type candidate frequency domain resource and the second-type candidate frequency domain resource within the deployment frequency band corresponding to the AMP device is greater than or equal to X₁ frequency domain units, and/or an interval between the center frequency point of the first signal and the center frequency point of the second signal is greater than or equal to X₁ frequency domain units, where X₁ is a positive integer.

In some embodiments, a frequency domain unit in the X₁ frequency domain units is one of: a candidate frequency domain resource, a channel, a system bandwidth, a carrier, a subcarrier, a physical resource block (PRB), a bandwidth part (BWP), a megahertz (MHz), a kilohertz (kHz), and a hertz (Hz).

In some embodiments, the X₁ frequency domain units are agreed upon by a protocol, or the X₁ frequency domain units are configured by a network device, or the X₁ frequency domain units are determined based on a clock frequency factor reported by the AMP device.

In some embodiments, in a case where m=1 and n=1, the first-type candidate frequency domain resource and the second-type candidate frequency domain resource within the deployment frequency band corresponding to the AMP device are adjacent to each other.

In some embodiments, in a case where m≥2 and n≥2, the deployment frequency band corresponding to the AMP device includes a plurality of groups of bound candidate frequency domain resources;
where each group of bound candidate frequency domain resources in the plurality of groups of bound candidate frequency domain resources includes at least one of the first-type candidate frequency domain resources and at least one of the second-type candidate frequency domain resources.

In some embodiments, the plurality of groups of bound candidate frequency domain resources are agreed upon by a protocol, or the plurality of groups of bound candidate frequency domain resources are configured by a network device, or the plurality of groups of bound candidate frequency domain resources are determined based on information reported by the AMP device.

In some embodiments, in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

In some embodiments, in each group of bound candidate frequency domain resources in the plurality of groups of bound candidate frequency domain resources, a first-type candidate frequency domain resource is adjacent to a second-type candidate frequency domain resource, or the first-type candidate frequency domain resource is not adjacent to the second-type candidate frequency domain resource.

In some embodiments, in each group of bound candidate frequency domain resources in the plurality of groups of bound candidate frequency domain resources, a first-type candidate frequency domain resource and a second-type candidate frequency domain resource meet a preset relationship.

In some embodiments, in each group of bound candidate frequency domain resources in the plurality of groups of bound candidate frequency domain resources, the first-type candidate frequency domain resource and the second-type candidate frequency domain resource meet the following formula:

$$F 1 = F 2 + Δ F ;$$

where F1 represents the first-type candidate frequency domain resource, F2 represents the second-type candidate frequency domain resource, and ΔF represents a frequency domain interval.

In some embodiments, the m first-type candidate frequency domain resources are agreed upon by a protocol; or
the m first-type candidate frequency domain resources are configured by a network device; or
the m first-type candidate frequency domain resources are preempted and indicated to the AMP device by the network device; or
the m first-type candidate frequency domain resources are determined based on information reported by the AMP device.

In some embodiments, in a case where the m first-type candidate frequency domain resources are configured by the network device, a configuration granularity of the m first-type candidate frequency domain resources includes one of: an AMP granularity, an AMP group granularity, and a cell granularity.

In some embodiments, a frequency domain resource in the first-type candidate frequency domain resource that is available for transmitting the first signal is configured by a network device, or the frequency domain resource in the first-type candidate frequency domain resource that is available for transmitting the first signal is agreed upon by a protocol, or the frequency domain resource in the first-type candidate frequency domain resource that is available for transmitting the first signal is determined based on information reported by the AMP device.

In some embodiments, in a case where the frequency domain resource in the first-type candidate frequency domain resource that is available for transmitting the first signal is configured by the network device, a configuration granularity of the frequency domain resource in the first-type candidate frequency domain resource that is available for transmitting the first signal includes one of: an AMP granularity, an AMP group granularity, and a cell granularity.

In some embodiments, the n second-type candidate frequency domain resources are agreed upon by a protocol; or
the n second-type candidate frequency domain resources are configured by the network device; or
the n second-type candidate frequency domain resources are determined based on information reported by the AMP device; or
the n second-type candidate frequency domain resources are preempted and indicated to the AMP device by the network device.

In some embodiments, in a case where the n second-type candidate frequency domain resources are configured by the network device, a configuration granularity of the n second-type candidate frequency domain resources includes one of: an AMP granularity, an AMP group granularity, and a cell granularity.

In some embodiments, a frequency domain resource in the second-type candidate frequency domain resource that is available for transmitting the second signal is configured by a network device, or the frequency domain resource in the second-type candidate frequency domain resource that is available for transmitting the second signal is agreed upon by a protocol, or the frequency domain resource in the second-type candidate frequency domain resource that is available for transmitting the second signal is determined based on information reported by the AMP device.

In some embodiments, in a case where the frequency domain resource in the second-type candidate frequency domain resource that is available for transmitting the second signal is configured by the network device, a configuration granularity of the frequency domain resource in the second-type candidate frequency domain resource that is available for transmitting the second signal includes one of: an AMP granularity, an AMP group granularity, and a cell granularity.

In some embodiments, in a case where the candidate frequency domain resource used for transmission of the first signal is the same as the candidate frequency domain resource used for transmission of the second signal, all candidate frequency domain resources within a deployment frequency band corresponding to the AMP device include s third-type candidate frequency domain resources, where a third-type candidate frequency domain resource is a candidate frequency domain resource available for transmitting the first signal and the second signal, and s is a positive integer.

In some embodiments, a frequency domain resource in the third-type candidate frequency domain resource that is available for transmitting the first signal is different from a frequency domain resource in the third-type candidate frequency domain resource that is available for transmitting the second signal.

In some embodiments, an interval between a frequency domain resource in the third-type candidate frequency domain resource that is available for transmitting the first signal and a frequency domain resource in the third-type candidate frequency domain resource that is available for transmitting the second signal is greater than or equal to X₂ frequency domain units, and X₂ is a positive integer.

In some embodiments, a frequency domain unit in the X₂ frequency domain units is one of: a channel, a system bandwidth, a carrier, a subcarrier, a PRB, a BWP, a MHz, a kHz, and a Hz.

In some embodiments, the X₂ frequency domain units are agreed upon by a protocol, or the X₂ frequency domain units are configured by a network device, or the X₂ frequency domain units are determined based on a clock frequency factor reported by the AMP device.

In some embodiments, there are guard periods on both sides of a frequency domain resource in the third-type candidate frequency domain resource that is available for transmitting the first signal, and/or there are guard periods on both sides of a frequency domain resource in the third-type candidate frequency domain resource that is available for transmitting the second signal;
where the guard periods are not available for transmitting a radio frequency signal therein.

In some embodiments, sizes of the guard periods on both sides of the frequency domain resource in the third-type candidate frequency domain resource that is available for transmitting the first signal are equal, or the sizes of the guard periods on both sides of the frequency domain resource in the third-type candidate frequency domain resource that is available for transmitting the first signal are unequal; and/or sizes of the guard periods on both sides of the frequency domain resource in the third-type candidate frequency domain resource that is available for transmitting the second signal are equal, or the sizes of the guard periods on both sides of the frequency domain resource in the third-type candidate frequency domain resource that is available for transmitting the second signal are unequal.

In some embodiments, the third-type candidate frequency domain resource includes a plurality of groups of bound frequency domain resources;
where each group of bound frequency domain resources in the plurality of groups of bound frequency domain resources includes at least one frequency domain resource available for transmitting the first signal and at least one frequency domain resource available for transmitting the second signal.

In some embodiments, the plurality of groups of bound frequency domain resources are agreed upon by a protocol, or the plurality of groups of bound frequency domain resources are configured by a network device, or the plurality of groups of bound frequency domain resources are determined based on information reported by the AMP device, or the plurality of groups of bound frequency domain resources are associated with at least one of: an identifier of the AMP device, or an identifier of an AMP group to which the AMP device belongs.

In some embodiments, in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

In some embodiments, the s third-type candidate frequency domain resources are configured by a network device; or
the s third-type candidate frequency domain resources are determined based on information reported by the AMP device; or
the s third-type candidate frequency domain resources are preempted and indicated to the AMP device by the network device.

In some embodiments, in a case where the s third-type candidate frequency domain resources are preempted and indicated to the AMP device by the network device, the third-type candidate frequency domain resources are successfully preempted in response to that: there is no interference on a frequency domain resource in the third-type candidate frequency domain resource that is available for transmitting the first signal, there is no interference on a frequency domain resource in the third-type candidate frequency domain resource that is available for transmitting the second signal, and there is no interference between the frequency domain resource in the third-type candidate frequency domain resource that is available for transmitting the first signal and the frequency domain resource in the third-type candidate frequency domain resource that is available for transmitting the second signal.

In some embodiments, in a case where the s third-type candidate frequency domain resources are preempted and indicated to the AMP device by the network device, the third-type candidate frequency domain resource and a candidate frequency domain resource adjacent thereto are both preempted by the network device, or only the third-type candidate frequency domain resource is preempted by the network device.

In some embodiments, a frequency domain resource in the third-type candidate frequency domain resource that is available for transmitting the first signal is configured by a network device, or the frequency domain resource in the third-type candidate frequency domain resource that is available for transmitting the first signal is agreed upon by a protocol, or the frequency domain resource in the third-type candidate frequency domain resource that is available for transmitting the first signal is determined based on information reported by the AMP device; and/or
a frequency domain resource in the third-type candidate frequency domain resource that is available for transmitting the second signal is configured by a network device, or the frequency domain resource in the third-type candidate frequency domain resource that is available for transmitting the second signal is agreed upon by a protocol, or the frequency domain resource in the third-type candidate frequency domain resource that is available for transmitting the second signal is determined based on information reported by the AMP device.

In some embodiments, in a case where the frequency domain resource in the third-type candidate frequency domain resource that is available for transmitting the first signal is configured by the network device, a configuration granularity of the frequency domain resource in the third-type candidate frequency domain resource that is available for transmitting the first signal includes one of: an AMP granularity, an AMP group granularity, and a cell granularity; and/or
in a case where the frequency domain resource in the third-type candidate frequency domain resource that is available for transmitting the second signal is configured by the network device, a configuration granularity of the frequency domain resource in the third-type candidate frequency domain resource that is available for transmitting the second signal includes one of: an AMP granularity, an AMP group granularity, and a cell granularity.

In some embodiments, a candidate frequency domain resource available for transmitting the first signal is shared by different AMP devices, and/or a candidate frequency domain resource available for transmitting the second signal is shared by different AMP devices; or
different candidate frequency domain resources available for transmitting the first signal are used by different AMP devices, and/or different candidate frequency domain resources available for transmitting the second signal are used by different AMP devices.

In some embodiments, in a case where the candidate frequency domain resource available for transmitting the first signal is shared by different AMP devices, the different AMP devices transmit the first signal using frequency division multiplexing (FDM); and/or
in a case where the candidate frequency domain resource available for transmitting the second signal is shared by different AMP devices, the different AMP devices transmit the second signal using FDM.

In some embodiments, within the deployment frequency band corresponding to the AMP device, different candidate frequency domain resources do not overlap, or different candidate frequency domain resources partially overlap.

In some embodiments, the candidate frequency domain resource is one of: a channel, a system bandwidth, a carrier bandwidth, a BWP, an aggregation/collection/bundling of a plurality of BWPs, an aggregation/collection/bundling of a plurality of subcarriers, and an aggregation/collection/bundling of a plurality of PRBs.

In some embodiments, the first signal is a signal transmitted periodically, or the first signal is a signal transmitted based on an event trigger, or the first signal is a signal transmitted in bundling with the second signal, or the first signal is a signal transmitted continuously; and/or
the second signal is a signal transmitted periodically, or the second signal is a signal transmitted based on an event trigger, or the second signal is a signal transmitted in bundling with the first signal, or the second signal is a signal transmitted continuously.

In some embodiments, the first signal is a single-frequency point signal, and/or the second signal is a single-frequency point signal.

In some embodiments, the first signal and/or the second signal is a narrowband signal with a bandwidth less than or equal to a preset value.

In some embodiments, the processing unit 320 is further configured to perform power harvesting based on the first signal and/or the second signal.

In some embodiments, the third signal is associated with high-order components obtained after processing of cross modulation or inter modulation on the first signal and the second signal.

In some embodiments, the first signal and the second signal are transmitted by a same device, or the first signal and the second signal are transmitted by different devices.

In some embodiments, the processing unit 320 is configured to:
perform envelope detection on the third signal.

In some embodiments, the communication unit may be a communication interface or a transceiver, or an input/output interface of a communication chip or a system on chip. The processing unit mentioned above may be one or more processors.

It should be understood that the AMP device 300 in accordance with the embodiments of the present disclosure may correspond to the AMP device in the method embodiments of the present disclosure, and the above-mentioned and other operations and/or functions of each unit in the AMP device 300 are respectively for implementing the corresponding processes of the AMP device in the method 200 shown in FIG. 10, which will not be repeated here for the sake of brevity.

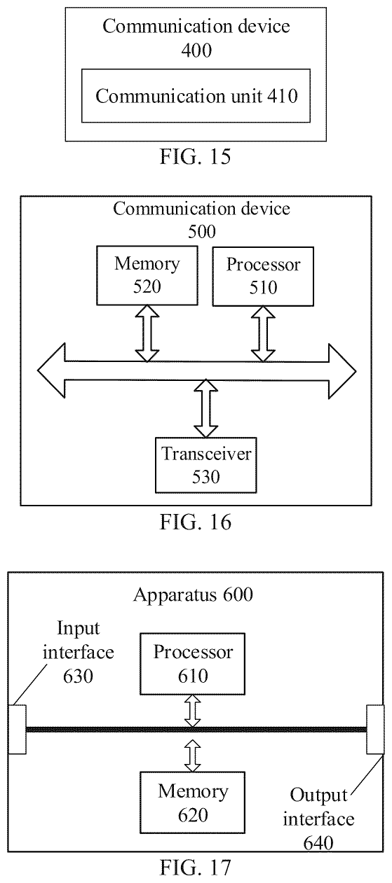

FIG. 15 shows a schematic block diagram of a communication device 400 in accordance with the embodiments of the present disclosure. As shown in FIG. 15, the communication device 400 is a first communication device, and the communication device 400 includes:
a communication unit 410, configured to transmit a first signal and/or a second signal to an ambient power (AMP) device;
wherein a third signal obtained through processing of cross modulation or inter modulation on the first signal and the second signal is used to determine a local clock of the AMP device; and
wherein in a case where the first communication device transmits only the first signal, the second signal is transmitted to the AMP device by a second communication device triggered by the first communication device; or in a case where the first communication device transmits only the second signal, the second signal is transmitted to the AMP device after being triggered by the second communication device.

In some embodiments, a center frequency point of the first signal is different from a center frequency point of the second signal; and/or a center frequency point of a frequency domain resource used for transmission of the first signal is different from a center frequency point of a frequency domain resource used for transmission of the second signal.

In some embodiments, the frequency domain resource used for transmission of the first signal is a candidate frequency domain resource, or the frequency domain resource used for transmission of the first signal is a partial frequency domain resource in a candidate frequency domain resource; and/or
the frequency domain resource used for transmission of the second signal is a candidate frequency domain resource, or the frequency domain resource used for transmission of the second signal is a partial frequency domain resource in a candidate frequency domain resource.

In some embodiments, the candidate frequency domain resource used for transmission of the first signal is different from the candidate frequency domain resource used for transmission of the second signal, or the candidate frequency domain resource used for transmission of the first signal is the same as the candidate frequency domain resource used for transmission of the second signal.

In some embodiments, in a case where the candidate frequency domain resource used for transmission of the first signal is different from the candidate frequency domain resource used for transmission of the second signal, all candidate frequency domain resources within a deployment frequency band corresponding to the AMP device include m first-type candidate frequency domain resources and n second-type candidate frequency domain resources, where a first-type candidate frequency domain resource is a candidate frequency domain resource available for transmitting the first signal, and a second-type candidate frequency domain resource is a candidate frequency domain resource available for transmitting the second signal, where m and n are both positive integers.

In some embodiments, the first-type candidate frequency domain resource within the deployment frequency band corresponding to the AMP device is not available for transmitting signals other than the first signal, and/or the second-type candidate frequency domain resource within the deployment frequency band corresponding to the AMP device is not available for transmitting signals other than the second signal.

In some embodiments, in a case where m=1 and n=1, an interval between the first-type candidate frequency domain and the second-type candidate frequency domain resource within the deployment frequency band corresponding to the AMP device is greater than or equal to X₁ frequency domain units, and/or an interval between the center frequency point of the first signal and the center frequency point of the second signal is greater than or equal to X₁ frequency domain units, where X₁ is a positive integer.

In some embodiments, a frequency domain unit in the X₁ frequency domain units is one of: a candidate frequency domain resource, a channel, a system bandwidth, a carrier, a subcarrier, a physical resource block (PRB), a bandwidth part (BWP), a megahertz (MHz), a kilohertz (kHz), and a hertz (Hz).

In some embodiments, the X₁ frequency domain units are agreed upon by a protocol, or the X₁ frequency domain units are configured by a network device, or the X₁ frequency domain units are determined based on a clock frequency factor reported by the AMP device.

In some embodiments, in a case where m=1 and n=1, the first-type candidate frequency domain resource and the second-type candidate frequency domain resource within the deployment frequency band corresponding to the AMP device are adjacent to each other.

In some embodiments, in a case where m≥2 and n≥2, the deployment frequency band corresponding to the AMP device includes a plurality of groups of bound candidate frequency domain resources;
where each group of bound candidate frequency domain resources in the plurality of groups of bound candidate frequency domain resources includes at least one of the first-type candidate frequency domain resources and at least one of the second-type candidate frequency domain resources.

In some embodiments, the plurality of groups of bound candidate frequency domain resources are agreed upon by a protocol, or the plurality of groups of bound candidate frequency domain resources are configured by a network device, or the plurality of groups of bound candidate frequency domain resources are determined based on information reported by the AMP device.

In some embodiments, in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

In some embodiments, in each group of bound candidate frequency domain resources in the plurality of groups of bound candidate frequency domain resources, a first-type candidate frequency domain resource is adjacent to a second-type candidate frequency domain resource, or the first-type candidate frequency domain resource is not adjacent to the second-type candidate frequency domain resource.

In some embodiments, in each group of bound candidate frequency domain resources in the plurality of groups of bound candidate frequency domain resources, a first-type candidate frequency domain resource and a second-type candidate frequency domain resource meet a preset relationship.

In some embodiments, in each group of bound candidate frequency domain resources in the plurality of groups of bound candidate frequency domain resources, the first-type candidate frequency domain resource and the second-type candidate frequency domain resource meet the following formula:

$$F 1 = F 2 + Δ F ;$$

where F1 represents the first-type candidate frequency domain resource, F2 represents the second-type candidate frequency domain resource, and ΔF represents a frequency domain interval.

In some embodiments, the m first-type candidate frequency domain resources are agreed upon by a protocol; or
the m first-type candidate frequency domain resources are configured by a network device; or
the m first-type candidate frequency domain resources are preempted and indicated to the AMP device by the network device; or
the m first-type candidate frequency domain resources are determined based on information reported by the AMP device.

In some embodiments, in a case where the m first-type candidate frequency domain resources are configured by the network device, a configuration granularity of the m first-type candidate frequency domain resources includes one of: an AMP granularity, an AMP group granularity, and a cell granularity.

In some embodiments, a frequency domain resource in the first-type candidate frequency domain resource that is available for transmitting the first signal is configured by a network device, or the frequency domain resource in the first-type candidate frequency domain resource that is available for transmitting the first signal is agreed upon by a protocol, or the frequency domain resource in the first-type candidate frequency domain resource that is available for transmitting the first signal is determined based on information reported by the AMP device.

In some embodiments, in a case where the frequency domain resource in the first-type candidate frequency domain resource that is available for transmitting the first signal is configured by the network device, a configuration granularity of the frequency domain resource in the first-type candidate frequency domain resource that is available for transmitting the first signal includes one of: an AMP granularity, an AMP group granularity, and a cell granularity.

In some embodiments, the n second-type candidate frequency domain resources are agreed upon by a protocol; or
the n second-type candidate frequency domain resources are configured by the network device; or
the n second-type candidate frequency domain resources are determined based on information reported by the AMP device; or
the n second-type candidate frequency domain resources are preempted and indicated to the AMP device by the network device.

In some embodiments, in a case where the n second-type candidate frequency domain resources are configured by the network device, a configuration granularity of the n second-type candidate frequency domain resources includes one of: an AMP granularity, an AMP group granularity, and a cell granularity.

In some embodiments, a frequency domain resource in the second-type candidate frequency domain resource that is available for transmitting the second signal is configured by a network device, or the frequency domain resource in the second-type candidate frequency domain resource that is available for transmitting the second signal is agreed upon by a protocol, or the frequency domain resource in the second-type candidate frequency domain resource that is available for transmitting the second signal is determined based on information reported by the AMP device.

In some embodiments, in a case where the frequency domain resource in the second-type candidate frequency domain resource that is available for transmitting the second signal is configured by the network device, a configuration granularity of the frequency domain resource in the second-type candidate frequency domain resource that is available for transmitting the second signal includes one of: an AMP granularity, an AMP group granularity, and a cell granularity.

In some embodiments, in a case where the candidate frequency domain resource used for transmission of the first signal is the same as the candidate frequency domain resource used for transmission of the second signal, all candidate frequency domain resources within a deployment frequency band corresponding to the AMP device include s third-type candidate frequency domain resources, where a third-type candidate frequency domain resource is a candidate frequency domain resource available for transmitting the first signal and the second signal, and s is a positive integer.

In some embodiments, a frequency domain resource in the third-type candidate frequency domain resource that is available for transmitting the first signal is different from a frequency domain resource in the third-type candidate frequency domain resource that is available for transmitting the second signal.

In some embodiments, an interval between a frequency domain resource in the third-type candidate frequency domain resource that is available for transmitting the first signal and a frequency domain resource in the third-type candidate frequency domain resource that is available for transmitting the second signal is greater than or equal to X₂ frequency domain units, where X₂ is a positive integer.

In some embodiments, a frequency domain unit in the X₂ frequency domain units is one of: a channel, a system bandwidth, a carrier, a subcarrier, a PRB, a BWP, a MHz, a kHz, and a Hz.

In some embodiments, the X₂ frequency domain units are agreed upon by a protocol, or the X₂ frequency domain units are configured by a network device, or the X₂ frequency domain units are determined based on a clock frequency factor reported by the AMP device.

In some embodiments, there are guard periods on both sides of a frequency domain resource in the third-type candidate frequency domain resource that is available for transmitting the first signal, and/or there are guard periods on both sides of a frequency domain resource in the third-type candidate frequency domain resource that is available for transmitting the second signal;
where the guard periods are not available for transmitting a radio frequency signal therein.

In some embodiments, sizes of the guard periods on both sides of the frequency domain resource in the third-type candidate frequency domain resource that is available for transmitting the first signal are equal, or the sizes of the guard periods on both sides of the frequency domain resource in the third-type candidate frequency domain resource that is available for transmitting the first signal are unequal; and/or sizes of the guard periods on both sides of the frequency domain resource in the third-type candidate frequency domain resource that is available for transmitting the second signal are equal, or the sizes of the guard periods on both sides of the frequency domain resource in the third-type candidate frequency domain resource that is available for transmitting the second signal are unequal.

In some embodiments, the third-type candidate frequency domain resource includes a plurality of groups of bound frequency domain resources;
where each group of bound frequency domain resources in the plurality of groups of bound frequency domain resources includes at least one frequency domain resource available for transmitting the first signal and at least one frequency domain resource that is available for transmitting the second signal.

In some embodiments, the plurality of groups of bound frequency domain resources are agreed upon by a protocol, or the plurality of groups of bound frequency domain resources are configured by a network device, or the plurality of groups of bound frequency domain resources are determined based on information reported by the AMP device, or the plurality of groups of bound frequency domain resources are associated with at least one of: an identifier of the AMP device, or an identifier of an AMP group to which the AMP device belongs.

In some embodiments, in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

In some embodiments, the s third-type candidate frequency domain resources are configured by a network device; or
the s third-type candidate frequency domain resources are determined based on information reported by the AMP device; or
the s third-type candidate frequency domain resources are preempted and indicated to the AMP device by the network device.

In some embodiments, in a case where the s third-type candidate frequency domain resources are preempted and indicated to the AMP device by the network device, the third-type candidate frequency domain resources are successfully preempted in response to that: there is no interference on a frequency domain resource in the third-type candidate frequency domain resource that is available for transmitting the first signal, there is no interference on a frequency domain resource in the third-type candidate frequency domain resource that is available for transmitting the second signal, and there is no interference between the frequency domain resource in the third-type candidate frequency domain resource that is available for transmitting the first signal and the frequency domain resource in the third-type candidate frequency domain resource that is available for transmitting the second signal.

In some embodiments, in a case where the s third-type candidate frequency domain resources are preempted and indicated to the AMP device by the network device, the third-type candidate frequency domain resource and a candidate frequency domain resource adjacent thereto are both preempted by the network device, or only the third-type candidate frequency domain resource is preempted by the network device.

In some embodiments, a frequency domain resource in the third-type candidate frequency domain resource that is available for transmitting the first signal is configured by a network device, or the frequency domain resource in the third-type candidate frequency domain resource that is available for transmitting the first signal is agreed upon by a protocol, or the frequency domain resource in the third-type candidate frequency domain resource that is available for transmitting the first signal is determined based on information reported by the AMP device; and/or
a frequency domain resource in the third-type candidate frequency domain resource that is available for transmitting the second signal is configured by a network device, or the frequency domain resource in the third-type candidate frequency domain resource that is available for transmitting the second signal is agreed upon by a protocol, or the frequency domain resource in the third-type candidate frequency domain resource that is available for transmitting the second signal is determined based on information reported by the AMP device.

In some embodiments, in a case where the frequency domain resource in the third-type candidate frequency domain resource that is available for transmitting the first signal is configured by the network device, a configuration granularity of the frequency domain resource in the third-type candidate frequency domain resource that is available for transmitting the first signal includes one of: an AMP granularity, an AMP group granularity, and a cell granularity; and/or
in a case where the frequency domain resource in the third-type candidate frequency domain resource that is available for transmitting the second signal is configured by the network device, a configuration granularity of the frequency domain resource in the third-type candidate frequency domain resource that is available for transmitting the second signal includes one of: an AMP granularity, an AMP group granularity, and a cell granularity.

In some embodiments, a candidate frequency domain resource available for transmitting the first signal is shared by different AMP devices, and/or a candidate frequency domain resource available for transmitting the second signal is shared by different AMP devices; or
different candidate frequency domain resources available for transmitting the first signal are used by different AMP devices, and/or different candidate frequency domain resources available for transmitting the second signal are used by different AMP devices.

In some embodiments, in a case where the candidate frequency domain resource available for transmitting the first signal is shared by different AMP devices, the different AMP devices transmit the first signal using frequency division multiplexing (FDM); and/or
in a case where the candidate frequency domain resource available for transmitting the second signal is shared by different AMP devices, the different AMP devices transmit the second signal using FDM.

In some embodiments, within the deployment frequency band corresponding to the AMP device, different candidate frequency domain resources do not overlap, or different candidate frequency domain resources partially overlap.

In some embodiments, the candidate frequency domain resource is one of: a channel, a system bandwidth, a carrier bandwidth, a BWP, an aggregation/collection/bundling of a plurality of BWPs, an aggregation/collection/bundling of a plurality of subcarriers, and an aggregation/collection/bundling of a plurality of PRBs.

In some embodiments, the first signal is a signal transmitted periodically, or the first signal is a signal transmitted based on an event trigger, or the first signal is a signal transmitted in bundling with the second signal, or the first signal is a signal transmitted continuously; and/or
the second signal is a signal transmitted periodically, or the second signal is a signal transmitted based on an event trigger, or the second signal is a signal transmitted in bundling with the first signal, or the second signal is a signal transmitted continuously.

In some embodiments, the first signal is a single-frequency point signal, and/or the second signal is a single-frequency point signal.

In some embodiments, the first signal and/or the second signal is a narrowband signal with a bandwidth less than or equal to a preset value.

In some embodiments, the first signal and/or the second signal is used for power harvesting by the AMP device.

In some embodiments, the third signal is associated with high-order components obtained after processing of cross modulation or inter modulation on the first signal and the second signal.

In some embodiments, the first signal and the second signal are transmitted by a same device, or the first signal and the second signal are transmitted by different devices.

In some embodiments, the third signal that is obtained through processing of cross modulation or inter modulation on the first signal and the second signal being used to determine the local clock of the AMP device, includes:
a signal obtained after envelope detection of the third signal is used to obtain or determine the local clock.

In some embodiments, the first communication device is one of: an access point AP, a station STA, a base station, a terminal device, and a transmission reception point (TRP).

In some embodiments, the communication unit mentioned above may be a communication interface or a transceiver, or an input/output interface of a communication chip or a system on chip. The processing unit mentioned above may be one or more processors.

It should be understood that the communication device 400 in accordance with the embodiments of the present disclosure may correspond to the first communication device in the method embodiments of the present disclosure, and the above-mentioned and other operations and/or functions of the unit in the communication device 400 are respectively for implementing the corresponding processes of the first communication device in the method 200 shown in FIG. 10, which will not be repeated here for the sake of brevity.

FIG. 16 is a schematic structural diagram of a communication device 500 provided in the embodiments of the present disclosure. The communication device 500 shown in FIG. 16 includes a processor 510, and the processor 510 may call a computer program from a memory and run the computer program to implement the method in the embodiments of the present disclosure.

In some embodiments, as shown in FIG. 16, the communication device 500 may further include a memory 520. The processor 510 may call a computer program from the memory 520 and run the computer program to implement the method in the embodiments of the present disclosure.

The memory 520 may be a separate device independent of the processor 510, or may be integrated into the processor 510.

In some embodiments, as shown in FIG. 16, the communication device 500 may further include a transceiver 530. The processor 510 may control the transceiver 530 to communicate with other devices. Optionally, the processor 510 may control the transceiver 530 to transmit information or data to other devices, or control the transceiver 530 to receive information or data transmitted by other devices.

The transceiver 530 may include a transmitter and a receiver. The transceiver 530 may further include an antenna, and there may be one or more antennas.

In some embodiments, the processor 510 may implement a function of the processing unit in the AMP device 300, or the processor 510 may implement a function of the processing unit in the communication device 400, which will not be described in detail here for the sake of brevity.

In some embodiments, the transceiver 530 may implement a function of the communication unit in the AMP device 300, which will not be described in detail here for the sake of brevity.

In some embodiments, the transceiver 530 may implement a function of the communication unit in the communication device 400, which will not be described in detail here for the sake of brevity.

In some embodiments, the communication device 500 may be the communication device 400 in the embodiments of the present disclosure, and the communication device 500 may implement the corresponding processes implemented by the first communication device in each method in the embodiment of the present disclosure, which will not be described in detail here for the sake of brevity.

In some embodiments, the communication device 500 may be the AMP device 300 in the embodiments of the present disclosure, and the communication device 500 may implement the corresponding processes implemented by the AMP device in each method in the embodiment of the present disclosure, which will not be described in detail here for the sake of brevity.

FIG. 17 is a schematic structural diagram of an apparatus provided in the embodiments of the present disclosure. The apparatus 600 shown in FIG. 17 includes a processor 610, and the processor 610 may call a computer program from a memory and run the computer program to implement the method in the embodiments of the present disclosure.

In some embodiments, as shown in FIG. 17, the apparatus 600 may further include a memory 620. The processor 610 may call a computer program from the memory 620 and run the computer program to implement the method in the embodiment of the present disclosure.

The memory 620 may be a separate device independent of the processor 610, or may be integrated into the processor 610.

In some embodiments, the processor 610 may implement a function of the processing unit in the AMP device 300, or the processor 610 may implement a function of the processing unit in the communication device 400, which will not be described in detail here for the sake of brevity.

In some embodiments, the apparatus 600 may further include an input interface 630. The processor 610 may control the input interface 630 to communicate with other devices or chips, and optionally, may control the input interface 630 to obtain information or data transmitted by other devices or chips. Optionally, the processor 610 may be located inside or outside a chip.

In some embodiments, the input interface 630 may implement a function of the communication unit in the AMP device 300, or the input interface 630 may implement a function of the communication unit in the communication device 400.

In some embodiments, the apparatus 600 may further include an output interface 640. The processor 610 may control the output interface 640 to communicate with other devices or chips, and optionally, may control the output interface 640 to output information or data to other devices or chips. Optionally, the processor 610 may be located inside or outside a chip.

In some embodiments, the output interface 640 may implement a function of the communication unit in the AMP device 300, or the output interface 640 may implement a function of the communication unit in the communication device 400.

In some embodiments, the apparatus may be applied to the communication device 400 in the embodiments of the present disclosure, and the apparatus may implement the corresponding processes implemented by the first communication device in each method in the embodiments of the present disclosure, which will not be described in detail here for the sake of brevity.

In some embodiments, the apparatus may be applied to the AMP device 300 in the embodiments of the present disclosure, and the apparatus may implement the corresponding processes implemented by the AMP device in each method in the embodiments of the present disclosure, which will not be described in detail here for the sake of brevity.

In some embodiments, the apparatus mentioned in the embodiments of the present disclosure may also be a chip. For example, the apparatus may be a system-on-chip, a system chip, a chip system, or a system-on-chip chip.

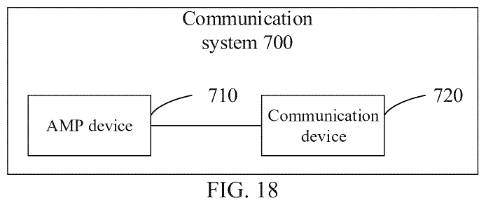

FIG. 18 is a schematic block diagram of a communication system 700 provided in the embodiments of the present disclosure. As shown in FIG. 18, the communication system 700 includes an AMP device 710 and a communication device 720.

The AMP device 710 may be configured to implement the corresponding functions implemented by the AMP device in the above methods, and the communication device 720 may be configured to implement the corresponding functions implemented by the first communication device in the above methods, which will not be described in detail here for the sake of brevity.

It should be understood that the processor in the embodiments of the present disclosure may be an integrated circuit chip with a capability for processing signals. In an implementation process, various steps of the method embodiments described above may be completed through an integrated logic circuit of hardware in a processor or instructions in a form of software. The above processor may be a general-purpose processor, a digital signal processor (DSP), an application specific integrated circuit (ASIC), a field programmable gate array (FPGA) or any of other programmable logic devices, a discrete gate or transistor logic device, or a discrete hardware component. The processor may implement or perform various methods, steps, and logic block diagrams disclosed in the embodiments of the present disclosure. The general-purpose processor may be a microprocessor, or the processor may be any conventional processor. The steps of the methods disclosed in combination with the embodiments of the present disclosure may be directly embodied by execution of a hardware decoding processor, or by execution of a combination of hardware and software modules in a decoding processor. The software module may be located in a storage medium commonly used in the art, such as a random access memory, a flash memory, a read-only memory, a programmable read-only memory or electrically erasable programmable memory, or a register. The storage medium is located in a memory, and the processor reads information in the memory and completes the steps of the above methods in combination with hardware of the processor.

It will be appreciated that the memory in the embodiments of the present disclosure may be a volatile memory or a non-volatile memory, or may include both the volatile memory and the non-volatile memory. The non-volatile memory may be a read-only memory (ROM), a programmable read-only memory (PROM), an erasable programmable read-only memory (EPROM), an electrically erasable programmable read-only memory (EEPROM), or a flash memory. The volatile memory may be a random access memory (RAM), which serves as an external cache. By way of example but not limited illustration, many forms of RAMs are available, such as a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DR RAM). It should be noted that the memories in the system and method described herein are intended to include, but are not limited to, these and any other suitable types of memories.

It should be understood that the above memories are exemplary but not limited illustration. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), or a Direct Rambus RAM (DR RAM). That is, the memories in the embodiments of the present disclosure are intended to include, but are not limited to, these and any other suitable types of memories.

The embodiments of the present disclosure further provide a non-transitory computer-readable storage medium for storing a computer program.

In some embodiments, the non-transitory computer-readable storage medium may be applied to the communication device in the embodiments of the present disclosure, and the computer program enables a computer to perform the corresponding processes implemented by the first communication device in the various methods in the embodiments of the present disclosure, which will not be repeated here for the sake of brevity.

In some embodiments, the non-transitory computer-readable storage medium may be applied to the AMP device in the embodiments of the present disclosure, and the computer program enables a computer to perform the corresponding processes implemented by the AMP device in the various methods in the embodiments of the present disclosure, which will not be repeated here for the sake of brevity.

The embodiments of the present disclosure further provide a computer program product, and the computer program product includes computer program instructions.

In some embodiments, the computer program product may be applied to the communication device in the embodiments of the present disclosure, and the computer program instructions enable a computer to perform the corresponding processes implemented by the first communication device in the various methods in the embodiments of the present disclosure, which will not be repeated here for the sake of brevity.

In some embodiments, the computer program product may be applied to the AMP device in the embodiments of the present disclosure, and the computer program instructions enable a computer to perform the corresponding processes implemented by the AMP device in the various methods in the embodiments of the present disclosure, which will not be repeated here for the sake of brevity.

The embodiments of the present disclosure further provide a computer program.

In some embodiments, the computer program may be applied to the communication device in the embodiments of the present disclosure. The computer program, when run on a computer, enables the computer to perform the corresponding processes implemented by the first communication device in the various methods in the embodiments of the present disclosure, which will not be repeated here for the sake of brevity.

In some embodiments, the computer program may be applied to the AMP device in the embodiments of the present disclosure. The computer program, when run on a computer, enables the computer to perform the corresponding processes implemented by the AMP device in the various methods in the embodiments of the present disclosure, which will not be repeated here for the sake of brevity.

Those ordinary skilled in the art will recognize that the units and algorithm steps of various examples described in combination with the embodiments disclosed herein can be implemented by electronic hardware, or a combination of computer software and electronic hardware. Whether these functions are performed in a form of hardware or software depends on a specific application and design constraints of the technical solution. Those skilled in the art may use different methods to implement the described functions for each specific application, but such implementation should not be considered to be beyond the scope of the present disclosure.

Those skilled in the art may clearly understand that, for convenience and brevity of description, working processes of the system, apparatus and unit as described above can refer to the corresponding processes in the aforementioned method embodiments, and details will not be repeated here.

In several embodiments provided in the present disclosure, it should be understood that the disclosed system, device/apparatus, and method may be implemented in other ways. For example, the device/apparatus embodiments described above are only illustrative. For example, the division of the units is only a logical function division, and there may be other division manners in actual implementation. For example, a plurality of units or components may be combined or integrated into another system, or some features may be ignored or not executed. In addition, coupling or direct coupling or communication connection shown or discussed between each other may be indirect coupling or communication connection via some interfaces, apparatuses, or units, which may be electrical, mechanical, or in other forms.

The units described as separate components may be or may not be physically separated, and the components shown as units may be or may not be physical units. That is, they may be located in one place or distributed over a plurality of network units. Some or all of the units may be selected according to actual needs to achieve the purpose of the solutions of the embodiments.

In addition, various functional units in various embodiments of the present disclosure may be integrated into one processing unit, or various unit may physically exist separately, or two or more units may be integrated into one unit.

The functions, if implemented in a form of software functional units and sold or used as an independent product, may be stored in a non-transitory computer-readable storage medium. With such understanding, the technical solutions of the present disclosure may be embodied in a form of a software product in essence, or a part of the technical solutions that contributes to the related art or a part of the technical solutions may be embodied in the form of the software product. The computer software product is stored in one storage medium including a number of instructions for enabling a computer device (which may be a personal computer, a server, or a network device) to perform all or some of the steps of the methods described in various embodiments of the present disclosure. The aforementioned storage media include a U disk, a mobile hard disk, a read-only memory (ROM), a random access memory (RAM), a magnetic disk, an optical disk, or any medium capable of storing program codes.

The above descriptions are only implementations of the present disclosure, but the protection scope of the present disclosure is not limited thereto. Changes or replacements that any person skilled in the art could readily conceive of within the technical scope of the present disclosure shall be included in the protection scope of the present disclosure. Therefore, the protection scope of the present disclosure shall be subject to the protection scope of the claims.

What is claimed is:

1. A wireless communication method, comprising:
receiving, by an ambient power (AMP) device, a first signal and a second signal;
performing, by the AMP device, processing of cross modulation or inter modulation on the first signal and the second signal to obtain a third signal; and
determining, by the AMP device, a local clock based on the third signal.

2. The method according to claim 1, wherein
a center frequency point of the first signal is different from a center frequency point of the second signal; and/or a center frequency point of a frequency domain resource used for transmission of the first signal is different from a center frequency point of a frequency domain resource used for transmission of the second signal.

3. The method according to claim 1, wherein
a frequency domain resource used for transmission of the first signal is a candidate frequency domain resource, or the frequency domain resource used for transmission of the first signal is a partial frequency domain resource in a candidate frequency domain resource; and/or
a frequency domain resource used for transmission of the second signal is a candidate frequency domain resource, or the frequency domain resource used for transmission of the second signal is a partial frequency domain resource in a candidate frequency domain resource.

4. The method according to claim 3, wherein the candidate frequency domain resource used for the transmission of the first signal is different from the candidate frequency domain resource used for the transmission of the second signal, or the candidate frequency domain resource used for the transmission of the first signal is same as the candidate frequency domain resource used for the transmission of the second signal.

5. The method according to claim 4, wherein
in a case where the candidate frequency domain resource used for the transmission of the first signal is different from the candidate frequency domain resource used for the transmission of the second signal, all candidate frequency domain resources within a deployment frequency band corresponding to the AMP device comprise m first-type candidate frequency domain resources and n second-type candidate frequency domain resources, wherein a first-type candidate frequency domain resource is a candidate frequency domain resource available for transmitting the first signal, and a second-type candidate frequency domain resource is a candidate frequency domain resource available for transmitting the second signal, wherein m and n are both positive integers.

6. The method according to claim 5, wherein
the first-type candidate frequency domain resource within the deployment frequency band corresponding to the AMP device is not available for transmitting signals other than the first signal, and/or the second-type candidate frequency domain resource within the deployment frequency band corresponding to the AMP device is not available for transmitting signals other than the second signal.

7. The method according to claim 5, wherein
in a case where m=1 and n=1, an interval between the first-type candidate frequency domain resource and the second-type candidate frequency domain resource within the deployment frequency band corresponding to the AMP device is greater than or equal to X₁ frequency domain units, and/or an interval between the center frequency point of the first signal and the center frequency point of the second signal is greater than or equal to X₁ frequency domain units, wherein X₁ is a positive integer; wherein
a frequency domain unit in the X₁ frequency domain units is one of: a candidate frequency domain resource, a channel, a system bandwidth, a carrier, a subcarrier, a physical resource block (PRB), a bandwidth part (BWP), a megahertz (MHz), a kilohertz (kHz), and a hertz (Hz); and/or
the X₁ frequency domain units are agreed upon by a protocol, or the X₁ frequency domain units are configured by a network device, or the X₁ frequency domain units are determined based on a clock frequency factor reported by the AMP device.

8. The method according to claim 5, wherein
in a case where m=1 and n=1, the first-type candidate frequency domain resource and the second-type candidate frequency domain resource within the deployment frequency band corresponding to the AMP device are adjacent to each other.

9. The method according to claim 5, wherein
in a case where m≥2 and n≥2, the deployment frequency band corresponding to the AMP device comprises a plurality of groups of bound candidate frequency domain resources;
wherein each group of bound candidate frequency domain resources in the plurality of groups of bound candidate frequency domain resources comprises at least one of the first-type candidate frequency domain resources and at least one of the second-type candidate frequency domain resources.

10. The method according to claim 9, wherein
the plurality of groups of bound candidate frequency domain resources are agreed upon by a protocol, or the plurality of groups of bound candidate frequency domain resources are configured by a network device, or the plurality of groups of bound candidate frequency domain resources are determined based on information reported by the AMP device, wherein
in a case where the plurality of groups of bound candidate frequency domain resources are configured by the network device, the plurality of groups of bound candidate frequency domain resources are preempted and indicated to the AMP device by the network device, or the plurality of groups of bound candidate frequency domain resources are semi-statically or dynamically configured by the network device.

11. The method according to claim 9, wherein in each group of bound candidate frequency domain resources in the plurality of groups of bound candidate frequency domain resources, a first-type candidate frequency domain resource is adjacent to a second-type candidate frequency domain resource, or the first-type candidate frequency domain resource is not adjacent to the second-type candidate frequency domain resource.

12. The method according to claim 9, wherein
in each group of bound candidate frequency domain resources in the plurality of groups of bound candidate frequency domain resources, a first-type candidate frequency domain resource and a second-type candidate frequency domain resource meet a preset relationship, wherein
in each group of bound candidate frequency domain resources in the plurality of groups of bound candidate frequency domain resources, the first-type candidate frequency domain resource and the second-type candidate frequency domain resource meet following formula:
$$F 1 = F 2 + Δ F ;$$
wherein F₁ represents the first-type candidate frequency domain resource, F₂ represents the second-type candidate frequency domain resource, and ΔF represents a frequency domain interval.

13. The method according to claim 5, wherein
the m first-type candidate frequency domain resources are agreed upon by a protocol; or
the m first-type candidate frequency domain resources are configured by a network device; or
the m first-type candidate frequency domain resources are preempted and indicated to the AMP device by the network device; or
the m first-type candidate frequency domain resources are determined based on information reported by the AMP device; wherein
in a case where the m first-type candidate frequency domain resources are configured by the network device, a configuration granularity of the m first-type candidate frequency domain resources comprises one of: an AMP granularity, an AMP group granularity, and a cell granularity.

14. The method according to claim 5, wherein
a frequency domain resource in the first-type candidate frequency domain resource that is available for transmitting the first signal is configured by a network device, or the frequency domain resource in the first-type candidate frequency domain resource that is available for transmitting the first signal is agreed upon by a protocol, or the frequency domain resource in the first-type candidate frequency domain resource that is available for transmitting the first signal is determined based on information reported by the AMP device, wherein
in a case where the frequency domain resource in the first-type candidate frequency domain resource that is available for transmitting the first signal is configured by the network device, a configuration granularity of the frequency domain resource in the first-type candidate frequency domain resource that is available for transmitting the first signal comprises one of: an AMP granularity, an AMP group granularity, and a cell granularity.

15. The method according to claim 5, wherein
the n second-type candidate frequency domain resources are agreed upon by a protocol; or
the n second-type candidate frequency domain resources are configured by a network device; or
the n second-type candidate frequency domain resources are determined based on information reported by the AMP device; or
the n second-type candidate frequency domain resources are preempted and indicated to the AMP device by the network device; wherein
in a case where the n second-type candidate frequency domain resources are configured by the network device, a configuration granularity of the n second-type candidate frequency domain resources comprises one of: an AMP granularity, an AMP group granularity, and a cell granularity.

16. The method according to claim 5, wherein
a frequency domain resource in the second-type candidate frequency domain resource that is available for transmitting the second signal is configured by a network device, or the frequency domain resource in the second-type candidate frequency domain resource that is available for transmitting the second signal is agreed upon by a protocol, or the frequency domain resource in the second-type candidate frequency domain resource that is available for transmitting the second signal is determined based on information reported by the AMP device, wherein
in a case where the frequency domain resource in the second-type candidate frequency domain resource that is available for transmitting the second signal is configured by the network device, a configuration granularity of the frequency domain resource in the second-type candidate frequency domain resource that is available for transmitting the second signal comprises one of: an AMP granularity, an AMP group granularity, and a cell granularity.

17. The method according to claim 4, wherein in a case where the candidate frequency domain resource used for the transmission of the first signal is the same as the candidate frequency domain resource used for the transmission of the second signal, all candidate frequency domain resources within the deployment frequency band corresponding to the AMP device comprise s third-type candidate frequency domain resources, wherein a third-type candidate frequency domain resource is a candidate frequency domain resource available for transmitting the first signal and the second signal, and s is a positive integer.

18. The method according to claim 17, wherein a frequency domain resource in the third-type candidate frequency domain resource that is available for transmitting the first signal is different from a frequency domain resource in the third-type candidate frequency domain resource that is available for transmitting the second signal;
and/or
an interval between a frequency domain resource in the third-type candidate frequency domain resource that is available for transmitting the first signal and a frequency domain resource in the third-type candidate frequency domain resource that is available for transmitting the second signal is greater than or equal to X₂ frequency domain units, and X₂ is a positive integer;
and/or
there are guard periods on both sides of a frequency domain resource in the third-type candidate frequency domain resource that is available for transmitting the first signal, and/or there are guard periods on both sides of a frequency domain resource in the third-type candidate frequency domain resource that is available for transmitting the second signal;
wherein the guard periods are not available for transmitting a radio frequency signal therein;
and/or
the s third-type candidate frequency domain resources are configured by a network device; or
the s third-type candidate frequency domain resources are determined based on information reported by the AMP device; or
the s third-type candidate frequency domain resources are preempted and indicated to the AMP device by the network device;
and/or
a frequency domain resource in the third-type candidate frequency domain resource that is available for transmitting the first signal is configured by a network device, or the frequency domain resource in the third-type candidate frequency domain resource that is available for transmitting the first signal is agreed upon by a protocol, or the frequency domain resource in the third-type candidate frequency domain resource that is available for transmitting the first signal is determined based on information reported by the AMP device; and/or
a frequency domain resource in the third-type candidate frequency domain resource that is available for transmitting the second signal is configured by a network device, or the frequency domain resource in the third-type candidate frequency domain resource that is available for transmitting the second signal is agreed upon by a protocol, or the frequency domain resource in the third-type candidate frequency domain resource that is available for transmitting the second signal is determined based on information reported by the AMP device.

19. A wireless communication method, comprising:
transmitting, by a first communication device, a first signal and/or a second signal to an ambient power (AMP) device;
wherein a third signal obtained through processing of cross modulation or inter modulation on the first signal and the second signal is used to determine a local clock of the AMP device; and
wherein in a case where the first communication device transmits only the first signal, the second signal is transmitted to the AMP device by a second communication device triggered by the first communication device; or in a case where the first communication device transmits only the second signal, the second signal is transmitted to the AMP device after being triggered by the second communication device.

20. An ambient power (AMP) device, comprising: a processor and a memory, wherein the memory is configured to store a computer program, and the processor is configured to call the computer program stored in the memory and run the computer program, to cause the AMP device to perform:
receiving a first signal and a second signal;
performing processing of cross modulation or inter modulation on the first signal and the second signal to obtain a third signal; and
determining a local clock based on the third signal.
